(19) United States
(12) Patent Application Publication
(10) Pub. No.: US 2022/0219997 A1
(43) Pub. Date: Jul. 14, 2022

(54) RHO-TYPE ZEOLITE, PRECURSORS THEREOF, METHODS FOR MAKING THE SAME AND USE OF THE ZEOLITE AS SORBENT FOR CO2

(71) Applicant: TOTAL SE, Courbevoie (FR)

(72) Inventors: Nicolas BARRIER, Caen (FR); Philippe BOULLAY, IFS (FR); Maxime DEBOST, Courbevoie (FR); Jean-Pierre GILSON, Cairon (FR); Julien GRAND, Viroflay (FR); Delphine MINOUX, Nivelles (BE); Svetlana MINTOVA, Basly (FR); Nikolai NESTERENKO, Nivelles (Thines) (BE)

(21) Appl. No.: 17/612,686

(22) PCT Filed: May 20, 2020
(86) PCT No.: PCT/EP2020/064171

§ 371 Date: Nov. 19, 2021

(30) Foreign Application Priority Data
Jun. 21, 2019 (EP) 19315045.5
Jun. 21, 2019 (EP) 19315047.1

(51) Int. Cl. C01B 39/46; B01J 20/18; B01D 53/02

(52) U.S. Cl. CPC C01B 39/46; B01J 20/18; B01D 53/02; B01D 2257/504; C01P 2002/88; C01P 2002/72; C01P 2002/01; C01P 2004/03; C01P 2004/04; C01P 2002/86

(57) ABSTRACT

The present disclosure relates to an RHO-type zeolite comprising caesium and M¹ _{wherein M}¹ is selected from Na and/or Li remarkable in that it has a Si/Al molar ratio comprised between 1.2 and 3.0 as determined by ²⁹Si magic angle spinning nuclear magnetic resonance, in that the RHO-type zeolite has a specific surface area comprised between 40 m²g⁻¹ and 250 m²g⁻¹ as determined by N₂ adsorption measurements, in that the RHO-type zeolite being in the form of one or more nanoparticles with an average crystal size comprised between 10 nm and 400 nm as determined by scanning electron microscopy wherein said nanoparticles form monodispersed nanocrystals or form aggregates of nanocrystals having an average size ranging from 100 nm to 500 nm, as determined by scanning electron microscopy. Amorphous precursors, devoid of an organic structure-directing agent, as well as a method for preparation of these amorphous precursors in the absence of such organic structure-directing agent and method for preparation of the RHO-type zeolites, are alos described. Finally, the use of the RHO-type zeolite as a sorbent for carbon dioxide is also demonstrated.

### TECHNICAL FIELD

The present disclosure relates deals with RHO-type zeolites that can be used as a sorbent for carbon dioxide. The present disclosure further relates to a method for making such RHO-type zeolites.

### TECHNICAL BACKGROUND

Zeolites and zeolite-like materials comprise a broad range of porous crystalline solids. The structures of zeolite-type materials are essentially based on tetrahedral networks which encompass channels and cavities. According to the study entitled “Nomenclature of structural and compositional characteristics of ordered microporous and mesoporous material with inorganic hosts” by McCusker L. B et al. (Pure Appl. Chem., 2001, 73, (2), 381-394), microporous crystalline materials with an inorganic, three-dimensional host structure composed of fully linked, corner-sharing tetrahedra and the same host topology constitute a zeolite framework type. The number of established framework or structure types has increased progressively in the last four to five decades of highly active research in the field of zeolites. Currently, the number of established structure types is clearly in excess of 239. All zeolite structure types are referenced with three capital letter codes. They have different framework densities, chemical compositions, dimensional channel systems and thus, different properties.

Zeolites are generally characterized by their high specific surface areas, high micropore volume, and capacity to undergo cation exchange. Therefore, they can be used in various applications, for example as catalysts (heterogeneous catalysis), absorbents, ion-exchangers, and membranes, in many chemical and petrochemical processes (e.g. in oil refining, fine- and petrochemistry).

Most of the described zeolites are aluminosilicate zeolites and comprise a three-dimensional framework of SiO₄ and AlO₄ tetrahedra. The electroneutrality of each tetrahedra containing aluminium is balanced by the inclusion in the crystal of a metallic cation, for example, a sodium cation. The micropore spaces (channels and cavities) are occupied by water molecules before dehydration.

The synthesis of nanosized zeolites in the absence of organic structure-directing agents

(OSDA) is an important research area in molecular sieve science since the reduction of the synthetic cost is of primary interest.

Over the past decade, renewed efforts were devoted to preparing zeolites with enhanced accessibility to their micropores, including post-synthesis modification, one-step hydrothermal crystallization in the presence of mesopore modifiers and synthesis of nanosized zeolite crystals with or without organic templates. The interest in the preparation of nanosized zeolites has gradually increased, but only 18 from the 239 structures known to date have so far been synthesized with nanosized dimensions and stabilized in colloidal suspensions. Indeed, the particle size reduction of zeolites to the nanometer scale leads to substantial changes in their properties such as increased external surface area and decreased diffusion path lengths. More particularly, the specific conditions employed to lead to nanosized zeolites change their intrinsic characteristics, impeding the full use of their potential.

In the study entitled “Template-free crystallization of zeolite RHO via hydrothermal synthesis: effects of synthesis time, synthesis temperature, water content and alkanility”, by Mousavi S. F. et al (Ceramics International, 2013, 39, 7149-7158), the synthesis of organic template-free RHO zeolite was investigated. It was found that by increasing the alkanality during the synthesis leads to a decrease in the crystal size, down to 400 nm; however, the zeolite showed a pollucite phase.

In the patent numbered US 2016/0101415, published in 2016, the synthesis of a zeolite RHO without the use of an organic structure-directing agent has been reported. A gel having the molar composition of 10 SiO₂: 1.0 AlO₃: 3.0 Na₂O: 0.4 Cs₂O: 80 H₂O has been prepared and has been heated for 1 to 3 days at 100° C. to retrieve a crystallized product which has an 8-membered ring channel. The crystallized product shows a microporous region and a mesoporous region with a micropore volume comprised between 0.03 cm³ g⁻¹ and 0.8 cm³ g⁻¹ of the composition, as determined by analysis of Ar sorption isotherms.

In the study entitled “Sorption of carbon dioxide, methane and nitrogen on zeolite-F: Equilibrium adsorption study”, by Belani M. R. et al. (Environmental Progress & Sustainable

Energy, 2017, 36 (3), 850-856), the use of a zeolite from the EDI framework, zeolite-F, with a size of the micrometric range, synthesized from the batch composition 3 SiO₂: 1.0 Al₂O₃: 5.26 K₂O: 94.5 H₂O and thus without an organic template, revealed, at a temperature of 303 K (29.85° C.) and a pressure of 850 mmHg (1.13 bar), high selectivity for carbon dioxide in comparison to methane (CO₂/CH₄=30) and nitrogen gas (CO₂/N₂=38). At those conditions, the CO₂ uptake by the zeolite-F was measured to be of 1.869 mmol/g. The use of RHO zeolite in pressure swing adsorption (PSA) and methane upgrading, such as CO₂ removal from methane, is also described in US2019/091652.

In the patent numbered U.S. Pat. No. 3,904,738, RHO zeolites having a (Na₂O+Cs₂O)/SiO₂ ratio ranging from 0.2 to 0.5 are disclosed. To prepare such RHO zeolites, an incubation time of four days at room temperature is required before a heating period of seven days at 80° C.

The study entitled “Synthesis of Cs-ABW nanozeolite in organotemplate-free system” of Ali Ghrear Tamara Mahmoud et al. (Microporous and Mesoporous material, 2019, 277, 78-83) concerns a hydrothermal synthesis of nanosized Cs-ABW zeolite in which a first solution comprising the silicate and caesium precursors is mixed with a second solution comprising the aluminate and caesium precursors.

The objective of the present disclosure is to provide an RHO-type zeolite that allows good adsorption of carbon dioxide together with good selectively over nitrogen and/or methane. Another objective of the disclosure is to provide a process to produce such an RHO-type zeolite that is cost-effective.

### SUMMARY

It is an object of the disclosure to provide a new zeolite of the RHO-type and a process for the preparation of such zeolite. Another object is to provide the amorphous precursors of the new zeolite of the RHO-type and a process for the preparation of such amorphous precursors. Another object is to deal with the use of such RHO-type zeolites. A further object of the disclosure is to provide new zeolite of the RHO-type as a sorbent of carbon dioxide, that can be used in a method of preparing clathrate hydrate substance and that can be used as a catalyst in a chemical process.

According to a first aspect, the disclosure provides an RHO-type zeolite comprising caesium and M¹ wherein M¹ is selected from Na and/or Li remarkable in that the RHO-type zeolite has a Si/Al molar ratio comprised between 1.2 and 3.0 as determined by ²⁹Si magic angle spinning nuclear magnetic resonance, in that the RHO-type zeolite has a specific surface area comprised between 40 m²g⁻¹ and 250 m²g⁻¹ as determined by N₂ adsorption measurements, in that the RHO-type zeolite is in the form of one or more nanoparticles; and in that said nanoparticles have an average crystal size ranging from 10 nm to 400 nm as determined by the Scherrer equation; wherein said nanoparticles form monodispersed nanocrystals or form aggregates of nanocrystals having an average size ranging from 100 nm to 500 nm, as determined by scanning electron microscopy.

Surprisingly the inventors have found that it was possible to produce, without the need of an organic template, a zeolite of the RHO-type that is downsized and/or nanosized and has a low Si/Al molar ratio leading to a high content of cations (Li⁺ and/or Na⁺, Cs⁺). This reduces the accessibility of the nitrogen (with a diameter of 3.6 Å) that is used to determine the pore volume since the high content of cations partly block the pores. This feature is helpful for the capability of such RHO-type zeolite of behaving as a sorbent for carbon dioxide. It has also properties of being capable of adsorbing carbon dioxide (having a diameter of 3.3 |) selectively over methane (having a diameter of 3.8 Å). In fact, due to the different factors, such as the size, the electronic interactions and/or the electronic repulsions, in combination with the presence of the cations, the molecules of carbon dioxide can enter into the zeolite framework by displacing the cations, while the molecules of methane are not able to achieve this.

With preference, one or more of the following can be used to further define the composition of the RHO-type zeolite of the present disclosure:
The RHO-type zeolite has a Si/Al molar ratio determined by ²⁹Si magic angle spinning nuclear magnetic resonance, said Si/Al molar ratio is of at most 2.80, preferably of at most 2.50, more preferably of at most 2.40, even more preferably of at most 2.30, most preferably of at most 2.00, even most preferably of at most 1.90, or of at most 1.80 or of at most 1.70.
The RHO-type zeolite has a Si/Al molar ratio determined by ²⁹Si magic angle spinning nuclear magnetic resonance, said Si/Al molar ratio is of at least 1.25, preferably of at least 1.30, more preferably of at least 1.40, even more preferably of at least 1.45, and most preferably of at least 1.50.
The RHO-type zeolite has a Si/Al molar ratio determined by ²⁹Si magic angle spinning nuclear magnetic resonance, said Si/Al molar ratio is comprised between 1.30 and 2.50, preferably between 1.35 and 2.00, more preferably between 1.40 and 1.90, even more preferably between 1.45 and 1.80, most preferably between 1.50 and 1.70.
The RHO-type zeolite has an M¹/Al molar ratio ranging from 0.60 and 0.90 as determined by Inductively Coupled Plasma Optical Emission Spectrometry wherein M¹ is selected from Na and/or Li; preferably from 0.65 to 0.80; preferably between 0.67 and 0.78, more preferably between 0.70 and 0.75.
The RHO-type zeolite has Na/Al molar ratio ranging from 0.60 and 0.90 as determined by Inductively Coupled Plasma Optical Emission Spectrometry; preferably from 0.65 to 0.80; preferably between 0.67 and 0.78, more preferably between 0.70 and 0.75.
The RHO-type zeolite has an M¹/Cs molar ratio comprised ranging from 1.5 to 5.0 as determined by Inductively Coupled Plasma Optical Emission Spectrometry wherein M¹ is selected from Na and/or Li; preferably from 2.0 to 5.0, more preferably from 2.5 to 4.5, and even more preferably from 3 to 4.
The RHO-type zeolite has a Na/Cs molar ratio ranging from 1.5 to 5.0 as determined by Inductively Coupled Plasma Optical Emission Spectrometry; preferably from 2.0 to 5.0, more preferably from 2.5 to 4.5 and even more preferably from 3 to 4.
The RHO-type zeolite has a Cs/Al molar ratio ranging from 0.10 to 0.50 as determined by Inductively Coupled Plasma Optical Emission Spectrometry; preferably from 0.14 to 0.45, more preferably from 0.18 to 0.40, even more preferably from 0.19 to 0.38, most preferably from 0.20 to 0.35.

With preference, one or more of the following can be used to further define the RHO-type zeolite of the present disclosure:
The nanoparticles have an average crystal size ranging from 20 nm to 300 nm as determined by the Scherrer equation, preferably from 30 nm to 250 nm, more preferably from 40 nm to 200 nm, even more preferably from 50 nm to 150 nm, most preferably from 60 nm to 100 nm.
The nanoparticles have an average crystal size of at least 20 nm as determined by Scherrer equation; preferably at least 30 nm, more preferably at least 40 nm; even more preferably at least 50 nm and most preferably at least 60 nm.
The nanoparticles have an average crystal size of at most 350 nm as determined by Scherrer equation; preferably at most 300 nm, more preferably at most 250 nm, even more preferably of at most 200 nm, most preferably of at most 150 nm and even most preferably of at most 100 nm.
The RHO-type zeolite forms nanoparticles with a specific surface area comprised between 50 m²g⁻¹ and 200 m²g⁻¹ as determined by N₂ adsorption measurements, preferably comprised between 60 m²g⁻¹ and 150 m²g⁻¹; more preferably comprised between 70 m²g⁻¹ and 120 m²g⁻¹.
The RHO-type zeolite comprises a pore volume comprised between 0.06 cm³ g⁻¹ and 0.40 cm³ g⁻¹ as determined by N₂ sorption measurements, preferably between 0.08 cm³ g⁻¹ and 0.35 cm³ g⁻¹, even preferably between 0.10 cm³ g⁻¹ and 0.32 cm³ g⁻¹.
The RHO-type zeolite forms nanoparticles which are nanocrystals with a hexagonal shape, as determined by transmission electron microscopy.
The aggregates have an average size ranging from 150 nm to 450 nm as determined by scanning electron microscopy, preferably from 200 nm to 400 nm, more preferably from 250 nm to 350 nm, even more preferably from 275 nm to 300 nm.
The aggregates have an average size of at least 120 nm as determined scanning electron microscopy; preferably at least 150 nm, more preferably at least 200 nm; even more preferably at least 250 nm and most preferably at least 275 nm.
The aggregates have an average size of at most 480 nm as determined by scanning electron microscopy; preferably at most 450 nm, more preferably at most 400 nm, even more preferably of at most 350 nm, most preferably of at most 320 nm and even most preferably of at most 300 nm.
The RHO-type zeolite comprises a combination of at least two lta cages linked by one 8-membered double ring.
Said nanoparticles have an average pore size diameter ranging from 3.4 Å to 3.8 Å, as determined by Brunauer-Emmet-Teller experiments, preferably ranging from 3.5 Å to 3.7 Å, more preferably of 3.6 Å.

According to a second aspect, the disclosure provides an amorphous precursor for the preparation of an RHO-type zeolite according to the first aspect, remarkable in that it has a molar composition comprising

10 SiO₂: a Al₂O₃: b M¹₂0: c Cs₂O: d H₂O,

wherein a, b, c, and d are coefficients

wherein
the coefficient a is ranging from at least 0.6 to at most 1.2;
the coefficient b is ranging from at least 5.3 to at most 9.0;
the coefficient c is ranging from at least 0.25 to at most 0.70; and
the coefficient d is ranging from at least 70 to at most 300;

and wherein M¹ is selected from Na and/or Li; with preference, M¹₂O is or comprises Na₂O.

According to the disclosure, the molar composition is devoid of an organic structure-directing agent.

Surprisingly, the inventors have found that a precursor as defined in the second aspect of the disclosure provides for the development of nanosized RHO-type zeolite according to the first aspect. It is evidenced that the amorphous precursors do not contain any template except the caesium cation and the sodium cation and/or the lithium cation.

For example, the coefficient a is ranging from at least 0.8 to at most 1.0; the coefficient b is ranging from at least 5.5 to at most 8.5; the coefficient c is ranging from at least 0.29 to at most 0.60, and the coefficient d is ranging from at least 80 to at most 300.

With preference, one or more of the following embodiments can be used to better define the amorphous precursor of RHO-type zeolite of the present disclosure:
M¹ is Na.
The coefficient a is ranging from at least 0.8 to at most 1.0; preferably from at least 0.8 to at most 0.9; more preferably is equal to 0.8.
The coefficient b is ranging from at least 5.5 to at most 8.5; preferably from at least 6.5 to at most 8.0.
The coefficient c is ranging from at least 0.29 to at most 0.60; preferably from at least 0.33 to at most 0.58.
The coefficient d is ranging from at least 80 to at most 300; preferably from at least 80 to at most 250 at most 190; more preferably from 90 to at most 110.
The coefficient d is at most 250; preferably at most 200, more preferably at most 190, even more preferably at most 160; most preferably at most 150, and even most preferably at most 110.
The amorphous precursor of RHO-type zeolite has a pH ranging between 12 and 14. The average crystal size of the RHO-type zeolite of the first aspect decreases when the pH of the amorphous precursor of RHO-type zeolite of the second aspect increases.
The (M¹₂O+Cs₂O)/SiO₂ ratio is at least 0.56 wherein M¹ is selected from Na and/or Li; preferably at least 0.60, more preferably at least 0.65 and even more preferably at least 0.67.
The (Na₂O+Cs₂O)/SiO₂ ratio is at least 0.56; preferably at least 0.60, more preferably at least 0.65 and even more preferably at least 0.67.
The (M¹₂O+Cs₂O)/SiO₂ ratio is ranging from 0.60 to 1.00 wherein M¹ is selected from Na and/or Li; preferably from 0.62 to 0.95; more preferably from 0.65 to 0.90; and most preferably from 0.67 to 0.88.
The (Na₂O+Cs₂O)/SiO₂ ratio is ranging from 0.60 to 1.00, preferably from 0.62 to 0.95; more preferably from 0.65 to 0.90; and most preferably from 0.67 to 0.88.
The ratio M¹₂O/H₂O is superior or equal to 0.015, preferably superior or equal to 0.025, more preferably superior or equal to 0.03, even more preferably superior or equal to 0.05, most preferably superior or equal to 0.07. The ratio M¹₂O/H₂O is the ratio b/d.
The ratio M¹₂O/Al₂O₃ is superior or equal to 4.0, preferably superior or equal to 7.0, more preferably superior or equal to 7.5, even more preferably superior or equal to 8.0, most preferably superior or equal to 12.0. The ratio M¹₂O/Al₂O₃ is the ratio b/a.
The ratio Cs₂O/Al₂O₃ is inferior or equal to 0.90, preferably inferior or equal to 0.80, more preferably inferior or equal to 0.75, even more preferably inferior or equal to 0.60. The ratio Cs₂O/Al₂O₃ is the ratio c/a.

According to a third aspect, the disclosure provides for a method for the preparation of an amorphous precursor of RHO-type zeolite as defined per the second aspect of the disclosure, comprising the following steps,
a) providing an aluminate precursors aqueous suspension;
b) providing a silicate precursors aqueous suspension;
c) adding one or more caesium precursors and one or more additional precursors selected from one or more sodium precursors and/or one or more lithium precursors, in the said aluminate precursors aqueous suspension to form a first aqueous suspension and/or in the said silicate precursors aqueous suspension to form a second aqueous suspension
d) forming an amorphous precursor of RHO-type zeolite by adding dropwise said aluminate precursors aqueous suspension into said second aqueous suspension or by adding dropwise said silicate precursors aqueous suspension into said first aqueous suspension, or by adding dropwise the said first or the said second aqueous suspension into said second or said first aqueous suspension;

wherein said first aqueous suspension and said second aqueous suspension are organic structure-directing agent-free.

Surprisingly, the inventors have found that the preparation of amorphous precursors of RHO-type zeolite without the use of template except for one or more caesium precursors and one or more additional precursors selected from one or more sodium precursors and/or one or more lithium precursors (no organic structure-directing agent (OSDA) is present) can lead to a mixture that is capable of being transformed into crystalline RHO zeolite. Additionally, the amorphous precursors prepared by this method have the interesting advantage to form crystals that are downsized and/or nanosized, that have large pore volumes and that have a low Si/Al molar ratio leading to a high content of cations (Na⁺, Cs⁺).

In a first and particularly preferred embodiment, said step (c) is the step of adding, in the aluminate precursors aqueous suspension, one or more caesium precursors and one or more additional precursors selected from one or more sodium precursors and/or one or more lithium precursors, to form a first aqueous suspension and said step (d) is the step of adding dropwise the silicate precursors aqueous suspension on the first aqueous suspension.

Surprisingly, the inventors have demonstrated that adding the one or more caesium precursors and one or more additional precursors selected from one or more sodium precursors and/or one or more lithium precursors in the aluminate precursors aqueous suspension, and adding dropwise the silicate precursors aqueous suspension into the first aqueous suspension allows for stabilizing the pH. There is no drop of pH, upon slow addition of the silicate precursors aqueous suspension. This has for effect to increase the Si/Al molar ratio of the crystalline zeolite upon crystallization. The amorphous precursors, will, upon crystallization, form monodispersed (i.e. discrete) RHO-type downsized and/or nanosized zeolite. Moreover, providing a higher Si/Al molar ratio to the crystalline RHO-type zeolite allows for a better sorption capacity of the zeolite towards carbon dioxide. This is why this embodiment is particularly preferred.

In a second preferred embodiment, alternative to the first embodiment, said step (c) is the step of adding, in the silicate precursors aqueous suspension, one or more caesium precursors and one or more additional precursors selected from one or more sodium precursors and/or one or more lithium precursors, to form a second aqueous suspension and said step (d) is the step of adding dropwise the aluminate precursors aqueous suspension on the second aqueous suspension.

Surprisingly, the inventors have found that upon crystallization, the amorphous precursors will provide aggregates of RHO-type nanosized zeolites.

The Aluminate Precursors Aqueous Suspension

With preference, one or more of the following embodiments can be used to better define the aluminate precursors aqueous suspension:
The one or more aluminate precursors are selected among Na₂Al₂O₄, Al₂(SO₄)₃, hydrated alumina, aluminium powder, AlCl₃, Al(OH)₃, kaolin clays and a mixture thereof, preferably Na₂Al₂O₄ (note: another notation for Na₂Al₂O₄ is NaAlO₂)
Na₂Al₂O₄, when selected, comprised between 48 wt. % and 63 wt. % of Al₂O₃ and between 37 wt. % and 52 wt. % of Na₂O, preferably 53 wt. % of Al₂O₃ and 47 wt. % of Na₂O.
The one or more aluminate precursors are present in an amount comprised between 2.5 wt. % and 25 wt. % of the total weight of the aluminate precursors aqueous suspension, preferably between 3 wt. % and 20 wt. %, more preferably between 4 wt. % and 8 wt. %.
The aluminate precursor aqueous suspension comprises water, preferably distilled water, more preferably double distilled water.

The Silicate Precursors Aqueous Suspension

With preference, one or more of the following embodiments can be used to better define the aluminate precursors aqueous suspension
The one or more silicate precursors of the silicate precursors aqueous suspension are selected among colloidal silica, silica oxyhydroxide species, silica hydrogel, silicic acid, fumed silica, tetraalkyl orthosilicates, silica hydroxides, precipitated silica, clays and a mixture thereof, preferably colloidal silica.
Colloidal silica, when selected, comprises amorphous, nonporous, and spherical silica particles in an aqueous suspension in an amount comprised between 20 wt. % and 50 wt. % of the total weight of said aqueous suspension, preferably between 25 wt. % and 45 wt. %, more preferably of 30 wt. % or 40 wt. %.
The one or more silicate precursors of the silicate precursors aqueous suspension are present in an amount comprised between 20 wt. % and 50 wt. % of the total weight of the silicate precursors aqueous suspension, preferably between 25 wt. % and 40 wt. %, more preferably between 30 wt. % and 35 wt. %.
The silicate precursors aqueous suspension comprises water, preferably distilled water, more preferably double distilled water.

The Metallic Precursors

In an embodiment, the one or more caesium precursors is or comprises CsOH; and/or the one or more sodium precursors is or comprises NaOH, and/or the one or more lithium precursors is or comprises LiOH.

The First Aqueous Suspension

In a preferred embodiment, the content of the one or more caesium precursors and one or more additional precursors selected from one or more sodium precursors and/or one or more lithium precursors in the first aqueous suspension is ranging from 1 wt. % to 97.5 wt. % of the total weight of the first aqueous suspension, preferably from 20 wt. % to 80 wt. %, more preferably from 25 wt. % and 55 wt. %, and most preferably from 30 to 50 wt. %. In a preferred embodiment, the first aqueous suspension comprises water and:
from 5.0 to 15.0 wt. % based on the total weight of the first aqueous suspension of one or more aluminate precursors; preferably from 5.5 to 12.5 wt. %; more preferably from 6.0 to 11.5 wt. %; even more preferably from 6.5 to 10.0 wt. %.

and from 15 wt. % to 80 wt. % of the one or more caesium precursors and one or more additional precursors selected from one or more sodium precursors and/or one or more lithium precursors, comprising
from 1 to 30 wt. % based on the total weight of the first aqueous suspension of one or more caesium precursors; and
from 14 to 50 wt. % based on the total weight of the first aqueous suspension of one or more additional precursors selected from one or more sodium precursors and/or one or more lithium precursors; preferably one or more sodium precursors.

With preference, the first aqueous suspension comprises at most 30 wt. % based on the total weight of the first aqueous suspension of one or more caesium precursors; preferably at most 25 wt. %; more preferably at most 20 wt. %; even more preferably at most 15 wt. %; and most preferably at most 10 wt. %.

With preference, the first aqueous suspension comprises at least 1 wt. % based on the total weight of the first aqueous suspension of one or more caesium precursors; preferably at least 1.5 wt. %; more preferably at least 2 wt. %; even more preferably at least 2.5 wt. %; and most preferably at least 3 wt. %.

With preference, the first aqueous suspension comprises at most 50 wt. % based on the total weight of the first aqueous suspension of one or more additional precursors selected from sodium precursors, and/or lithium precursors; preferably at most 48 wt. %; more preferably at most 45 wt. %; even more preferably at most 40 wt. %; and most preferably at most 38 wt. %.

With preference, the first aqueous suspension comprises at least 14 wt. % based on the total weight of the first aqueous suspension of one or more additional precursors selected from sodium precursors, and/or lithium precursors; preferably at least 15 wt. %; more preferably at least 20 wt. %; even more preferably at least 22 wt. %; and most preferably at least 25 wt. %.

With preference, the first aqueous suspension comprises from 25 to 45 wt. % based on the total weight of the first aqueous suspension of one or more additional precursors selected from one or more sodium precursors and/or one or more lithium precursors; preferably one or more sodium precursors.

The Second Aqueous Suspension

In another embodiment, the content of the one or more caesium precursors and one or more additional precursors selected from one or more sodium precursors and/or one or more lithium precursors in the second aqueous suspension is ranging from 1 wt. % to 97.5 wt. % of the total weight of the second aqueous suspension, preferably from 20 wt. % to 80 wt. %, more preferably from 25 wt. % and 55 wt. %, and most preferably from 30 to 50 wt. %.

In a more preferred embodiment, the second aqueous suspension comprises water and:
from 10 to 35 wt. % based on the total weight of the second aqueous suspension of one or more silicate precursors; preferably from 15 to 30 wt. %; more preferably from 18 to 27 wt. %; and
from 10 wt. % to 60 wt. % of the one or more caesium precursors and one or more additional precursors selected from one or more sodium precursors and/or one or more lithium precursors, comprising:
   from 1 to 25 wt. % based on the total weight of the second aqueous suspension of one or more caesium precursors; and
   from 9 to 35 wt. % based on the total weight of the second aqueous suspension of one or more additional precursors selected from one or more sodium precursors and/or one or more lithium precursors; preferably one or more sodium precursors.

With preference, the second aqueous suspension comprises at most 25 wt. % based on the total weight of the second aqueous suspension of one or more caesium precursors; preferably at most 20 wt. %; more preferably at most 15 wt. %; even more preferably at most 10 wt. %; and most preferably at most 5 wt. %.

With preference, the second aqueous suspension comprises at least 1 wt. % based on the total weight of the second aqueous suspension of one or more caesium precursors; preferably at least 1.5 wt. %; more preferably at least 2 wt. %; even more preferably at least 2.5 wt. %; and most preferably at least 3 wt. %.

With preference, the second aqueous suspension comprises at most 35 wt. % based on the total weight of the second aqueous suspension of one or more additional precursors selected from one or more sodium precursors and/or one or more lithium precursors; preferably at most 30 wt. %; more preferably at most 25 wt. %; even more preferably at most 20 wt. %; and most preferably at most 15 wt. %.

With preference, the second aqueous suspension comprises at least 9 wt. % based on the total weight of the second aqueous suspension of one or more additional precursors selected from one or more sodium precursors and/or one or more lithium precursors; preferably at least 8 wt. %; more preferably at least 7 wt. %; even more preferably at least 6 wt. %; and most preferably at least 5 wt. %.

With preference, the second aqueous suspension comprises from 25 to 45 wt. % based on the total weight of the second aqueous suspension of one or more additional precursors selected from one or more sodium precursors and/or one or more lithium precursors; preferably one or more sodium precursors.

The Formation of the Amorphous Precursor

In a preferred embodiment, the weight ratio of the aqueous suspension containing one or more aluminate precursors over the aqueous suspension containing one or more silicate precursors is comprised between 0.2 and 2, and more preferably between 0.4 and 1.2; wherein the aqueous suspension containing one or more aluminate precursors is the aluminate precursors aqueous suspension or the first aqueous suspension; and the aqueous suspension containing one or more silicate precursors is the second aqueous suspension or the silicate precursors aqueous suspension, respectively. With preference, the one or more embodiments can be used to better define the step d):
The dropwise addition of the aqueous suspension containing one or more aluminate precursors over the aqueous suspension containing one or more silicate precursors is performed in a temperature comprised between −5° C. and 25° C., preferably in a temperature comprised between 20° C. and 25° C.
The dropwise addition of the aqueous suspension containing one or more aluminate precursors over the aqueous suspension containing one or more silicate precursors is performed under stirring, preferably under stirring of at least 500 rpm, more preferably of at least 750 rpm.
The dropwise addition of the aqueous suspension containing one or more silicate precursors over the aqueous suspension containing one or more aluminate precursors is performed in a temperature comprised between −5° C. and 25° C., preferably in a temperature comprised between 20° C. and 25° C.
The dropwise addition of the aqueous suspension containing one or more silicate precursors over the aqueous suspension containing one or more aluminate precursors is performed under stirring, preferably under stirring of at least 500 rpm, more preferably of at least 750 rpm.

According to a fourth aspect, the disclosure provides a method for the preparation of an RHO-type zeolite according to the first aspect, comprising the method for the preparation of an amorphous precursor of RHO-type zeolite according to the third aspect of the disclosure and further comprising the following steps:
e) mixing said amorphous precursor at a temperature comprised between 20° C. and 30° C.;
f) heating said amorphous precursor at a temperature comprised between 50° C. and 140° C. during a time comprised between 0.5 hours and 90 hours, such as to form one or more crystals of RHO-type zeolite;
g) optionally, recovering said one or more crystals of RHO-type zeolite.

Surprisingly, the inventors have found a method to prepare RHO-type zeolites that are nanosized and that exhibits a low Si/Al molar ratio. This low Si/Al molar ratio allows for high content of cations, such as Na⁺ or Cs⁺, in the environment of the RHO-type zeolite. This reduces the accessibility of the nitrogen that is used to determine the pore volume since the high content of cations partly block the pores. This feature is helpful for the capability of such RHO-type zeolite of behaving as a sorbent for carbon dioxide. It has also properties of being capable of adsorbing carbon dioxide selectively over methane. The method of the present disclosure further affords a high crystalline yield (at least 60%) and provide a narrow particle size distribution.

With preference, one or more of the following embodiments can be used to better define the method for preparation of the RHO-type zeolite of the present disclosure:
Said step (e) is carried out for at least 8 hours and of at most 32 hours, more preferably of at least 13 h, even more preferably of at least 14 hours.
Said step (e) is carried out in a sealed environment, preferably at a pressure of 0.1 MPa.
Said step (e) is carried out under stirring.
Said stirring is selected from magnetic stirring or mechanical stirring or is a first type of stirring during a first period of at least 2 hours and a second type of stirring after said the first period for a second period of at least 6 hours, more preferably the first type of stirring is magnetic stirring or mechanical stirring, and/or the second type of stirring is orbital stirring or shaking.
Said amorphous precursor has after step (e) and before step (f) a refractive index ranging between 1.303 and 1.363, preferably between 1.313 and 1.353, more preferably between 1.323 and 1.343, even more preferably is 1.333; said refractive index is determined by refractometry. In other words, said amorphous precursor is after step (e) and before step (f) in the form of a water clear suspension.
Step (f) is carried out at a temperature comprised between 60° C. and 130° C., preferably between 70° C. and 120° C., more preferably between 80° C. and 110° C.
Step (f) is conducted for a time ranging from.0.5 hour to 72 hours, preferably from 0.75 hour to24 hours, more preferably from 1 hour to 8 hours.
Step (f) is conducted for a time of at most 48 hours; preferably at most 24 hours, more preferably at most 10 hours, even more preferably at most 8 hours and most preferably for at most 6 hours.
Step (f) is carried out in a sealed environment.
Step (f) is carried out under autogenous pressure conditions.
Step (f) is performed in the absence of seed crystals.
The method further comprises the step of cooling down said one or more crystals of the RHO-type zeolite at a temperature comprised between 20° C. and 25° C. after said step (f).
The step (g), when present, comprises the sub-steps of adding water and separating the one or more crystals of RHO-type zeolite.
The sub-step of separating the one or more crystals of RHO-type zeolite is carried out by filtration and/or by centrifugation and/or by dialysis and/or by adding flocculating agents followed by filtration, preferably by centrifugation.
The sub-step of adding water is repeated until the pH of the decanting water reaches a pH comprised between 6.5 and 8.5, preferably between 7 and 8.
The step (g), when present, optionally comprises the sub-step of drying after the sub-step of separating the one or more crystals of RHO-type zeolite.
The optional sub-step of drying is carried by lyophilization, preferably the lyophilization is performed at a temperature comprised between −100° C. and −70° C., more preferably comprised between −92° C. and −76° C.
Said method, when step (g) is present, further comprises a step (h) of performing an ion-exchange.
The ion-exchange of step (h) is carried out in presence of one salt, the cation of said salt being selected from the alkali metals, the alkaline earth metal, or ammonium; and the anion of said salt is selected from halogens or nitrate, preferably from chloride or nitrate.

According to a fifth aspect, the disclosure provides for a use of the RHO-type zeolite as defined in the first aspect as a sorbent for carbon dioxide; with preference in a process for separation of carbon dioxide from methane or in a process for separation of carbon dioxide from an inert gas such as N2, He and/or Ar.

Surprisingly, the inventors have found that the RHO-type zeolite of the disclosure is very efficient in the sorption of carbon dioxide. Without being bound by theory, the elevated amount of the pore volume allows for such interesting properties. It is thus possible to develop a system with the RHO-type zeolite of the first aspect of the disclosure which is used to separate CO₂ from other gases, such as methane and/or nitrogen.

According to a sixth aspect, the disclosure provides for a use of the RHO-type zeolite as defined in the first aspect as an adsorbent for carbon dioxide, preferably as selective adsorbent towards carbon dioxide over methane.

Therefore, the disclosure provides a method comprising sorbing polar molecules (H₂O, CO₂) over less polar ones (N₂, CH₄), and thus separating H₂O- and/or CO₂-containing gas mixture, sorbing lower alkanes thus separating alkanes from alkenes (C₂-C₄), or separating nitrogen from a nitrogen-hydrogen gas mixture, by contacting the respective feedstock with the RHO-type zeolite composition of the disclosure. A method for those separations could be managed as thin films, hollow fibers or membranes assembled from only or a part of the RHO-type zeolite composition of the disclosure.

According to a seventh aspect, the disclosure provides for a use of the RHO-type zeolite as defined per the first aspect of the disclosure in a method of preparing clathrate hydrate substance or clathrate gas substance, wherein said clathrate hydrate or clathrate gas entraps preferentially methane.

According to an eighth aspect, the disclosure provides for a use of the RHO-type zeolite as defined per the first aspect of the disclosure as a catalyst in a chemical process.

### DESCRIPTION OF THE FIGURES

FIG. 1 represents the X-Ray Diffraction (XRD) spectrum of the synthetic zeolite material RHO-1, RHO-2 and RHO-3. The intensity is shown in arbitrary units (a.u.) as a function of the angle 2θ (in degrees) in the range of 5°-50°.

FIG. 2 represents the ²⁷Al magic angle spinning nuclear magnetic resonance (MAS NMR) spectrum of the synthetic zeolite material RHO-1, RHO-2 and RHO-3 between 150 ppm and −10 ppm.

FIG. 3 represents the ²⁹Si magic angle spinning nuclear magnetic resonance (MAS NMR) spectrum of the synthetic zeolite material RHO-1, RHO-2 and RHO-3 between −50 ppm and −130 ppm.

FIG. 4 shows the scanning electron microscope (SEM) images of the synthetic zeolite material RHO-1, RHO-2 and RHO-3.

FIG. 5 shows the transmission electron microscope (TEM) images of the synthetic zeolite material RHO-1, RHO-2 and RHO-3.

FIG. 6 shows the thermogravimetric analyses (TGA) of the synthetic zeolite material RHO-1, RHO-2 and RHO-3.

FIG. 7 represents the N₂ sorption isotherms of the synthetic zeolite material RHO-1, RHO-2 and RHO-3.

FIG. 8 represents the CO₂ sorption isotherms of the synthetic zeolite material RHO-1, RHO-2 and RHO-3.

FIG. 9 represents the sorption capacity towards CO₂ of the synthetic zeolite material RHO-1, RHO-2 and RHO-3, obtained by TGA under CO₂ flow.

FIG. 10 represents the sorption behaviour of RHO-3 monitored by FTIR in ten consecutive cycles of CO₂ adsorption and desorption at 350°.

FIG. 11 represents the stability of RHO-3 after sorption cycles determined by XRD analysis after FTIR.

FIG. 12 represents the sorption behaviour of RHO-3 monitored by TGA in ten consecutive cycles of CO₂ adsorption and desorption at 350°.

FIG. 13 represents the stability of RHO-3 after sorption cycles determined by XRD analysis after TGA.

FIG. 14 represents the absorption capacity of RHO-3 towards carbon dioxide and methane.

### DETAILED DESCRIPTION OF THE DISCLOSURE

For the disclosure, the following definitions are given:

The terms “nanosized” and “nanozeolites” refers to crystals of zeolite having a size lower than 200 nm.

Zeolite codes (e.g., RHO . . . ) are defined according to the “Atlas of Zeolite Framework Types”, 6^{th} revised edition, 2007, Elsevier, to which the present application also refers.

The term “alkali metal” refers to an element classified as an element from group 1 of the periodic table of elements, excluding hydrogen. According to this definition, the alkali metals are Li, Na, K, Rb, Cs and Fr.

The term “alkaline earth metal” refers to an element classified as an element from group 2 of the periodic table of elements. According to this definition, the alkaline earth metals are Be, Mg, Ca, Sr, Ba and Ra.

The yield to particular chemical compounds is determined as the mathematical product between the selectivity to said particular chemical compounds and the conversion rate of the chemical reaction. The mathematical product is expressed as a percentage.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

The particular features, structures, characteristics or embodiments may be combined in any suitable manner, as would be apparent to a person skilled in the art from this disclosure, in one or more embodiments.

Method for Preparing the Precursor of the RHO-Type Zeolite

The disclosure provides for a method for the preparation of an amorphous precursor of RHO-type zeolite, comprising the following steps,
a) providing an aluminate precursors aqueous suspension;
b) providing a silicate precursors aqueous suspension;
c) adding one or more caesium precursors and one or more additional precursors selected from one or more sodium precursors and/or one or more lithium precursors, in the said aluminate precursors aqueous suspension to form a first aqueous suspension and/or in the said silicate precursors aqueous suspension to form a second aqueous suspension
d) forming an amorphous precursor of RHO-type zeolite by adding dropwise said aluminate precursors aqueous suspension into said second aqueous suspension or by adding dropwise said silicate precursors aqueous suspension into said first aqueous suspension, or by adding dropwise the said first or the said second aqueous suspension into said second or said first aqueous suspension;

wherein said first aqueous suspension and said second aqueous suspension are organic structure-directing agent-free.

The one or more aluminate precursors in the aluminate precursors aqueous suspension provided in step (a) are preferably selected among Na₂Al₂O₄, Al₂(SO₄)₃, hydrated alumina, aluminium powder, AlCl₃, Al(OH)₃, kaolin clays and a mixture thereof, preferably Na₂Al₂O₄.

Na₂Al₂O₄, when selected, comprised between 48 wt. % and 63 wt. % of Al₂O₃ and between 37 wt. % and 52 wt. % of Na₂O, preferably 53 wt. % of Al₂O₃ and 47 wt. % of Na₂O.

The one or more aluminate precursors in the aluminate precursors aqueous suspension provided in step (a) are preferably present in an amount comprised between 2.5 wt. % and 25 wt. % of the total weight of the aluminate precursors aqueous suspension, preferably between 3 wt. % and 20 wt. %, more preferably between 4 wt. % and 8 wt. %. The aluminate precursors aqueous suspension comprises water, preferably distilled water, more preferably double distilled water.

The one or more silicate precursors in the second aqueous suspension provided in step (b) are preferably selected among colloidal silica, silica oxyhydroxide species, silica hydrogel, silicic acid, fumed silica, tetraalkyl orthosilicates, silica hydroxides, precipitated silica, clays and a mixture thereof, preferably colloidal silica. Colloidal silica, when selected, comprises amorphous, nonporous, and spherical silica particles in an aqueous suspension in an amount comprised between 20 wt. % and 50 wt. % of the total weight of said aqueous suspension, preferably between 25 wt. % and 45 wt. %, more preferably of 30 wt. % (e.g. Ludox®HS30) or 40 wt. % (e.g. Ludox®HS40).

The one or more silicate precursors in the silicate precursors aqueous suspension provided in step (b) are present in an amount comprised between 20 wt. % and 50 wt. % of the total weight of the silicate precursors aqueous suspension, preferably between 25 wt. % and 40 wt. %, more preferably between 30 wt. % and 35 wt. %. The silicate precursors aqueous suspension comprises water, preferably distilled water, more preferably double distilled water.

In a first and particularly preferred embodiment, said step (c) is the step of adding in the aluminate precursors aqueous suspension one or more caesium precursors and one or more additional precursors selected from one or more sodium precursors and/or one or more lithium precursors to form a first aqueous suspension and said step (d) is the step of adding dropwise the silicate precursors aqueous suspension on the first aqueous suspension. This operating process allows for stabilizing the pH of the first aqueous suspension and for reducing the number of free cations. As the pH does not vary that much, the whole structure of the zeolite is stabilized and has for effect to increase the Si/Al molar ratio once the precursor will crystallize into RHO-type zeolite. Such a phenomenon will allow for improving the sorption capacity of the zeolite towards carbon dioxide. Additionally, upon crystallization, the amorphous precursors will form discrete RHO-type nanosized zeolites (i.e. monodispersed nanocrystals).

In a second preferred embodiment, alternative to the first embodiment, said step (c) is the step of adding one or more caesium precursors and one or more additional precursors selected from one or more sodium precursors and/or one or more lithium precursors in the silicate precursors aqueous suspension to form a second aqueous suspension and said step (d) is the step of adding dropwise the aluminate precursors aqueous suspension on the second aqueous suspension. This operating process will form amorphous precursors, that upon crystallization, will form aggregates of RHO-type nanosized zeolite.

The high cation content in both first and second embodiments allows for reducing the capacity of the RHO-type zeolite to adsorb nitrogen (diameter of 3.6 Å) and methane (diameter of 3.8 Å), by excluding them based on their size which is bigger than the one of carbon dioxide (diameter of 3.3 Å) and on electronic interactions and/or repulsions.

The one or more caesium precursors comprise an anion selected from a group of hydroxide, oxide, nitrate, sulfate, carbonate, dicarbonate, halogen, oxalate, citrate, and acetate anion or a mixture thereof, with preference, said anion is hydroxide anion. The caesium precursor is or comprises preferably CsOH.

The one or more sodium precursors comprise an anion selected from hydroxide, oxide, nitrate, sulfate, carbonate, dicarbonate, halogen, oxalate, citrate, acetate anion or a mixture thereof, with preference said anion is hydroxide anion. The sodium precursor is or comprises preferably NaOH.

The one or more lithium precursors comprise an anion selected from hydroxide, oxide, nitrate, sulfate, carbonate, dicarbonate, halogen, oxalate, citrate, acetate anion or a mixture thereof, with preference said anion is hydroxide anion. The lithium precursor is or comprises preferably LiOH.

In a preferred embodiment, the content of the one or more caesium precursors and one or more additional precursors selected from one or more sodium precursors and/or one or more lithium precursors in the first aqueous suspension is ranging from 1 wt. % to 97.5 wt. % of the total weight of the first aqueous suspension, preferably from 20 wt. % to 80 wt. %, more preferably from 25 wt. % and 55 wt. %, and most preferably from 30 to 50 wt. %.

In a preferred embodiment, the first aqueous suspension comprises water and:
from 5.0 to 15.0 wt. % based on the total weight of the first aqueous suspension of one or more aluminate precursors; preferably from 5.5 to 12.5 wt. %; more preferably from 6.0 to 11.5 wt. %; even more preferably from 6.5 to 10.0 wt. %.

and from 15 wt. % to 80 wt. % of the one or more caesium precursors and one or more additional precursors selected from one or more sodium precursors and/or one or more lithium precursors, comprising
from 1 to 30 wt. % based on the total weight of the first aqueous suspension of one or more caesium precursors; and
from 14 to 50 wt. % based on the total weight of the first aqueous suspension of one or more additional precursors selected from one or more sodium precursors and/or one or more lithium precursors; preferably one or more sodium precursors.

With preference, the first aqueous suspension comprises at most 30 wt. % based on the total weight of the first aqueous suspension of one or more caesium precursors; preferably at most 25 wt. %; more preferably at most 20 wt. %; even more preferably at most 15 wt. %; and most preferably at most 10 wt. %.

With preference, the first aqueous suspension comprises at least 1 wt. % based on the total weight of the first aqueous suspension of one or more caesium precursors; preferably at least 1.5 wt. %; more preferably at least 2 wt. %; even more preferably at least 2.5 wt. %; and most preferably at least 3 wt. %.

With preference, the first aqueous suspension comprises at most 50 wt. % based on the total weight of the first aqueous suspension of one or more additional precursors selected from sodium precursors, and/or lithium precursors; preferably at most 48 wt. %; more preferably at most 45 wt. %; even more preferably at most 40 wt. %; and most preferably at most 38 wt. %. With preference, the first aqueous suspension comprises at least 14 wt. % based on the total weight of the first aqueous suspension of one or more additional precursors selected from sodium precursors, and/or lithium precursors; preferably at least 15 wt. %; more preferably at least 20 wt. %; even more preferably at least 22 wt. %; and most preferably at least 25 wt. %. With preference, the first aqueous suspension comprises from 25 to 45 wt. % based on the total weight of the first aqueous suspension of one or more additional precursors selected from one or more sodium precursors and/or one or more lithium precursors; preferably one or more sodium precursors. In one embodiment, the first aqueous suspension comprises water and:
from 5.00 to 9.00 wt. % based on the total weight of the first aqueous suspension of one or more aluminate precursors;
from 33.01 wt. % to 80.00 wt. % based on the total weight of the first aqueous suspension of the one or more caesium precursors and one or more additional precursors selected from one or more sodium precursors and/or one or more lithium precursors.

In one instance, the first aqueous suspension comprises water and:
8.71 wt. % based on the total weight of the first aqueous suspension of one or more aluminate precursors;
4.96 wt. % based on the total weight of the first aqueous suspension of one or more caesium precursors; and
30.72 wt. % based on the total weight of the first aqueous suspension of one or more selected from one or more sodium precursors and/or one or more lithium precursors; preferably one or more sodium precursors.

The amorphous precursor obtained with such composition affords upon crystallization an RHO-type zeolite that has a CO₂ uptake of 1.56 mmol/g of zeolite material. In one embodiment, the first aqueous suspension comprises water and:
from 9.01 to 15.00 wt. % based on the total weight of the first aqueous suspension of one or more aluminate precursors;
from 15.00 wt. % to 33.00 wt. % based on the total weight of the first aqueous suspension of the one or more caesium precursors and one or more additional precursors selected from one or more sodium precursors and/or one or more lithium precursors.

The amorphous precursor obtained with such composition affords upon crystallization an RHO-type zeolite that has a CO₂ uptake of at least 2.00 mmol/g of zeolite material.

In a second instance, the first aqueous suspension comprises water and:
9.55 wt. % based on the total weight of the first aqueous suspension of one or more aluminate precursors;
3.11 wt. % based on the total weight of the first aqueous suspension of one or more caesium precursors; and
28.69 wt. % based on the total weight of the first aqueous suspension of one or more selected from one or more sodium precursors and/or one or more lithium precursors; preferably one or more sodium precursors.

The amorphous precursor obtained with such composition affords upon crystallization an RHO-type zeolite that has a CO₂ uptake of 2.16 mmol/g of zeolite material.

In another embodiment, the content of the one or more caesium precursors and one or more additional precursors selected from one or more sodium precursors and/or one or more lithium precursors in the second aqueous suspension is ranging from 1 wt. % to 97.5 wt. % of the total weight of the second aqueous suspension, preferably from 20 wt. % to 80 wt. %, more preferably from 25 wt. % and 55 wt. %, and most preferably from 30 to 50 wt. %.

In a more preferred embodiment, the second aqueous suspension comprises water and:
from 10 to 35 wt. % based on the total weight of the second aqueous suspension of one or more silicate precursors; preferably from 15 to 30 wt. %; more preferably from 18 to 27 wt. %; and
from 10 wt. % to 60 wt. % of the one or more caesium precursors and one or more additional precursors selected from one or more sodium precursors and/or one or more lithium precursors, comprising:
   from 1 to 25 wt. % based on the total weight of the second aqueous suspension of one or more caesium precursors; and
   from 9 to 35 wt. % based on the total weight of the second aqueous suspension of one or more additional precursors selected from one or more sodium precursors and/or one or more lithium precursors; preferably one or more sodium precursors.

The amorphous precursor obtained with such composition affords upon crystallization an RHO-type zeolite that has a CO₂ uptake comprised between 1.20 and 1.29 mmol/g of zeolite material.

With preference, the second aqueous suspension comprises at most 25 wt. % based on the total weight of the second aqueous suspension of one or more caesium precursors; preferably at most 20 wt. %; more preferably at most 15 wt. %; even more preferably at most 10 wt. %; and most preferably at most 5 wt. %.

With preference, the second aqueous suspension comprises at least 1 wt. % based on the total weight of the second aqueous suspension of one or more caesium precursors; preferably at least 1.5 wt. %; more preferably at least 2 wt. %; even more preferably at least 2.5 wt. %; and most preferably at least 3 wt. %.

With preference, the second aqueous suspension comprises at most 35 wt. % based on the total weight of the second aqueous suspension of one or more additional precursors selected from one or more sodium precursors and/or one or more lithium precursors; preferably at most 30 wt. %; more preferably at most 25 wt. %; even more preferably at most 20 wt. %; and most preferably at most 15 wt. %.

With preference, the second aqueous suspension comprises at least 9 wt. % based on the total weight of the second aqueous suspension of one or more additional precursors selected from one or more sodium precursors and/or one or more lithium precursors; preferably at least 8 wt. %; more preferably at least 7 wt. %; even more preferably at least 6 wt. %; and most preferably at least 5 wt. %.

With preference, the second aqueous suspension comprises from 25 to 45 wt. % based on the total weight of the second aqueous suspension of one or more additional precursors selected from one or more sodium precursors and/or one or more lithium precursors; preferably one or more sodium precursors.

In one instance, the second aqueous suspension comprises water and:
26.99 wt. % based on the total weight of the second aqueous suspension of one or more silicate precursors;
3.97 wt. % based on the total weight of the second aqueous suspension of one or more caesium precursors; and
24.56 wt. % based on the total weight of the second aqueous suspension of one or more selected from one or more sodium precursors and/or one or more lithium precursors; preferably one or more sodium precursors.

The amorphous precursor obtained with such composition affords upon crystallization an RHO-type zeolite that has a CO₂ uptake of 1.22 mmol/g of zeolite material.

In a preferred embodiment, the weight ratio of the aqueous suspension containing one or more aluminate precursors over the aqueous suspension containing one or more silicate precursors is comprised between 0.2 and 2, and more preferably between 0.4 and 1.2; wherein the aqueous suspension containing one or more aluminate precursors is the aluminate precursors aqueous suspension or the first aqueous suspension; and the aqueous suspension containing one or more silicate precursors is the second aqueous suspension or the silicate precursors aqueous suspension, respectively.

It is preferred that the dropwise addition of the aqueous suspension containing one or more aluminate precursors over the aqueous suspension containing one or more silicate precursors is performed in a temperature comprised between −5° C. and 25° C., preferably in a temperature comprised between 20° C. and 25° C. The dropwise addition of the aqueous suspension containing one or more aluminate precursors over the aqueous suspension containing one or more silicate precursors is advantageously performed under stirring, preferably under stirring of at least 500 rpm, more preferably of at least 750 rpm.

It is also preferred that the dropwise addition of the aqueous suspension containing one or more silicate precursors over the aqueous suspension containing one or more aluminate precursors is performed in a temperature comprised between −5° C. and 25° C., preferably in a temperature comprised between 20° C. and 25° C. The dropwise addition of the aqueous suspension containing one or more silicate precursors over the aqueous suspension containing one or more aluminate precursors is advantageously performed under stirring, preferably under stirring of at least 500 rpm, more preferably of at least 750 rpm.

The Precursor of the RHO-Type Zeolite

The disclosure also provides the precursor of RHO-type zeolite. The precursors of the RHO-type zeolite are obtainable by the method for the preparation of amorphous precursors of RHO-type zeolite described above. The precursor is amorphous and has a molar composition comprising

10 SiO₂: a Al₂O₃: b M¹₂O: c Cs₂O: d H₂O,

wherein a, b, c, and d are coefficients; and wherein

the coefficient a is ranging from at least 0.6 to at most 1.2;

the coefficient b is ranging from at least 5.3 to at most 9.0;

the coefficient c is ranging from at least 0.25 to at most 0.70; and

the coefficient d is ranging from at least 70 to at most 300;

and wherein M¹ is selected from Na and/or Li.

For example, the precursor is amorphous and has a molar composition comprising

10 SiO₂: a Al₂O₃: b M¹₂O: c Cs₂O: d H₂O,

wherein a, b, c, and d are coefficients; and wherein

0.8≤a≤1

5.5≤b≤8.5;

0.29≤c≤0.60; and

80≤d≤300;

wherein M¹ is selected from Na and/or Li; with preference, M¹₂O is or comprises Na₂O.

According to the disclosure, the molar composition is devoid of an organic structure-directing agent.

The amorphous precursors do not contain any seeds of previously formed crystal of RHO zeolite. The amorphous precursor of RHO-type zeolite is fluoride-free.

The (M¹₂O+Cs₂O)/SiO₂ ratio provides guidance to select the content of cations in the precursor which influences the size of the nanocrystals. Per the disclosure, the (M¹₂O+Cs₂O)/SiO₂ ratio can be selected as followed.

For example, the (M¹₂O+Cs₂O)/SiO₂ ratio is at least 0.56 wherein M¹ is selected from Na and/or Li; preferably at least 0.60, more preferably at least 0.65, even more preferably at least 0.67. Thus, in a preferred embodiment, M¹₂O is Na₂O; the (Na₂O+Cs₂O)/SiO₂ ratio is at least 0.56, preferably at least 0.60, more preferably at least 0.65, even more preferably at least 0.67.

For example, the (M¹₂O+Cs₂O)/SiO₂ ratio is ranging from 0.56 to 1.05, preferably from 0.60 to 1.00, more preferably from 0.62 to 0.95, even more preferably from 0.65 to 0.90, most preferably from 0.67 to 0.88. Thus, in a preferred embodiment, M¹₂O is Na₂O; the (Na₂O+Cs₂O)/SiO₂ ratio is ranging from 0.56 to 1.05, preferably from 0.60 to 1.00, more preferably from 0.62 to 0.95, even more preferably from 0.65 to 0.90, most preferably from 0.67 to 0.88.

The ratio M¹₂O/H₂O provides guidance to select the content of water in the precursor which influence the size of the nanocrystals.

For example, the ratio M¹₂O/H₂O is superior or equal to 0.015, preferably superior or equal to 0.025, more preferably superior or equal to 0.03, even more preferably superior or equal to 0.05, most preferably superior or equal to 0.07. The ratio M¹₂O/H₂O is the ratio b/d. Thus, in a preferred embodiment, M¹₂O is Na₂O; the ratio Na₂O/H₂O is superior or equal to 0.025, preferably superior or equal to 0.03, more preferably superior or equal to 0.05, even more preferably superior or equal to 0.07.

For example, the ratio M¹₂O/Al₂O₃ is superior or equal to 4.0, preferably superior or equal to 7.0, more preferably superior or equal to 7.5, even more preferably superior or equal to 8.0, most preferably superior or equal to 12.0. The ratio M¹₂O/Al₂O₃ is the ratio b/a. Thus, in a preferred embodiment, M¹₂O is Na₂O; the ratio Na₂O/Al₂O₃ is superior or equal to 4.0, preferably superior or equal to 7.0, more preferably superior or equal to 7.5, even more preferably superior or equal to 8.0, most preferably superior or equal to 12.0.

For example, the ratio Cs₂O/Al₂O₃ is inferior or equal to 0.90, preferably inferior or equal to 0.80, more preferably inferior or equal to 0.75, even more preferably inferior or equal to 0.60. The ratio Cs₂O/Al₂O₃ is the ratio c/a.

Advantageously, the coefficient a, attributed to the molar amount of alumina is equal to 0.8. With preference, the coefficient b, attributed to the molar amount of sodium oxide or of lithium oxide, preferably of sodium oxide, is ranging between 6.0 and 8.0, more preferably between 6.5 and 7.5, even more preferably is 6.6 or 8.0.

With preference, the coefficient c, attributed to the molar amount of caesium oxide, is ranging between 0.33 and 0.58, more preferably is 0.33 or 0.58.

With preference, the coefficient d, attributed to the molar amount water, is ranging between 90 and 250, more preferably between 95 and 200, even more preferably between 96 and 180, most preferably between 97 and 160, even most preferably is 100.

With preference, the amorphous precursor of RHO-type zeolite has a pH ranging between 12 and 14. The average crystal size of the RHO-type zeolite of the first aspect decreases when the pH of the amorphous precursor of RHO-type zeolite of the second aspect increases or becomes more basic.

When a first aqueous suspension is formed in step c) and when the silicate precursor aqueous suspension is added dropwise on the first aqueous suspension in step d), then the amount of the free cations will be contained, favouring thus the formation of discrete RHO-type downsized and/or nanosized RHO-type zeolite upon crystallization.

When a second aqueous suspension is formed in step c) and when the aluminate precursor aqueous suspension is added dropwise on the second aqueous suspension in step d), then the basicity of the second aqueous suspension being elevated (compared for example to the basicity of the first aqueous suspension), this will favour the formation of aggregated RHO-type zeolite upon crystallization.

In a more preferred embodiment, when the coefficient a, attributed to the molar amount of alumina is equal to 0.8, then b =8; c =0.58 and d =100.

In another more preferred embodiment, when the coefficient a, attributed to the molar amount of alumina is equal to 0.8, then b =6.6; c =0.33 and d =100.

Method for Preparing the RHO-Type Zeolite from the Precursor

The disclosure provides a method for the preparation of an RHO-type zeolite, comprising the method for the preparation of an amorphous precursor of RHO-type zeolite as described above and further comprising the following steps:
e) mixing said amorphous precursor at a temperature comprised between 20° C. and 30° C.;
f) heating said amorphous precursor at a temperature comprised between 50° C. and 140° C. during a time comprised between 0.5 hours and 90 hours, such as to form one or more crystals of RHO-type zeolite;
g) optionally, recovering said one or more crystals of RHO-type zeolite.

The mixing is performed by maintaining the suspension at room temperature (e.g., between 20° C. and 25° C.) in a closed space to avoid the water vapour. This temperature should be maintained for a time sufficient to favour the nucleation and to reduce the agglomeration of the amorphous nanoparticles of precursors and the crystalline phase. The pressure of the mixing step is preferably 0.1 MPa. The mixing is preferably carried out for at least 8 hours and of at most 32 hours, more preferably of at least 13 h, even more preferably of at least 14 hours. The mixing is preferably carried out under stirring. Advantageously, the stirring is selected from magnetic stirring or mechanical stirring or is a first type of stirring during a first period of at least 2 hours and a second type of stirring after said the first period for a second period of at least 6 hours, more preferably the first type of stirring is magnetic stirring or mechanical stirring, and/or the second type of stirring is orbital stirring or shaking. The stirring is carried out until the suspension becomes clear, or has a refractive index ranging between 1.303 and 1.363, preferably between 1.313 and 1.353, more preferably between 1.323 and 1.343, even more preferably is 1.333; said refractive index is determined by refractometry.

Once the suspension has been mixed, the homogeneous solution obtained is crystallized to generate the RHO-type zeolite. The heating step (f) is thus preferably performed at a temperature comprised between 60° C. and 130° C., preferably between 70° C. and 120° C., more preferably between 80° C. and 110° C. It is highlighted that if the crystallization temperature is too low (below 50° C.) or too high (above 140° C.), bigger crystals and contamination with other zeolite materials or low crystallinity is achieved. The crystallization is also performed in the absence of seed crystals. The crystallization is preferably carried out for a period comprised between 0.5 hour and 72 hours, preferably comprised between 0.75 hour and 24 hours, more preferably comprised between 1 hour and 8 hours. For example, step (f) is conducted for a time of at most 90 hours, preferably at most 72 hours, more preferably at most 48 hours, even more preferably at most 24 hours, most preferably at most 10 hours and even most preferably at most 6 hours. The crystallization is preferably carried out in a sealed environment and preferably carried out under autogenous pressure conditions.

In a preferred embodiment, a step of recovering said one or more crystals of RHO-type zeolite is performed, preferably after having cooled down he one or more crystals of the RHO-type zeolite at a temperature comprised between 20° C. and 25° C. The step of recovering is performed by achieving a washing step with the addition of water, preferably distilled water, more preferably double distilled water and followed by filtration, by centrifugation, by high- speed centrifugation (in which the samples are spun at at least 5000 rpm), by dialysis and/or by using flocculating agents followed by filtration. The water can have a temperature comprised between 70° C. and 90° C., preferably a temperature of 80° C. and is added until the pH of the decanting water reaches a pH comprised between 6.8 and 8.5, preferably between 7 and 8. In one instance, the step of recovering is performed by using double distilled water at 80° C. followed by high-speed centrifugation. The solid, which comprises the synthetic zeolite material, is thus separated from the mother liquor. The step of recovering can be repeated several times to remove all the materials that are not converted into synthetic zeolite material. When the nanocrystals have been recovered, they are optionally dried. This can be advantageously performed by lyophilization, for example at a temperature comprised between −100° C. and −70° C., more preferably at a temperature comprised between −92° C. and −76° C. An ion-exchange step can be performed on the one or more crystals of RHO-type zeolite. The ion-exchange step is carried out in presence of one salt, the cation of said salt being selected from the alkali metals, the alkaline earth metal, or ammonium; and the anion of said salt is selected from halogens or nitrate, preferably from chloride or nitrate. The protonic form of the nanocrystals of RHO-type zeolite can also be produced.

The RHO-Type Zeolite

The disclosure provides an RHO-type zeolite comprising caesium and M¹, wherein M¹ is selected from Na and/or Li, remarkable in that the RHO-type zeolite has a Si/Al molar ratio comprised between 1.2 and 3.0 as determined by ²⁹Si magic angle spinning nuclear magnetic resonance, in that the RHO-type zeolite has a specific surface area comprised between 40 m²g⁻¹ and 250 m²g⁻¹ as determined by N₂ adsorption measurements, in that the RHO-type zeolite is in the form of one or more nanoparticles; and in that the nanoparticles have an average crystal size ranging from 10 nm to 400 nm as determined by the Scherrer equation; wherein said nanoparticles form monodispersed nanocrystals or form aggregates of nanocrystals having an average size ranging from 100 nm to 500 nm, as determined by scanning electron microscopy.

The RHO-type zeolite forms nanoparticles with a specific surface area comprised between 50 m²g⁻¹ and 200 m²g⁻¹ as determined by N₂ adsorption measurements, preferably comprised between 60 m²g⁻¹ and 150 m²g⁻¹; more preferably comprised between 70 m²g⁻¹ and 120 m²g⁻¹. It is preferred that the RHO-type zeolite comprises a pore volume comprised between 0.06 cm³ g⁻¹ and 0.4 cm³ g⁻¹ as determined by N₂ sorption measurements, preferably between 0.08 cm³ g⁻¹ and 0.35 cm³ g⁻¹, even preferably between 0.1 cm³ g⁻¹ and 0.32 cm³ g⁻¹.

The RHO-type zeolite has preferably a Si/Al molar ratio determined by ²⁹Si magic angle spinning nuclear magnetic resonance, said Si/Al molar ratio is comprised between 1.30 and 2.50, more preferably between 1.35 and 2.00, even more preferably between 1.40 and 1.90, most preferably between 1.45 and 1.80, even most preferably between 1.50 and 1.70.

For example, the RHO-type zeolite has a Si/Al molar ratio determined by ²⁹Si magic angle spinning nuclear magnetic resonance, said Si/Al molar ratio is of at most 2.80, preferably of at most 2.50, more preferably of at most 2.40, even more preferably of at most 2.30, most preferably of at most 2.00, even most preferably of at most 1.90, or of at most 1.80 or of at most 1.70.

For example, said Si/Al molar ratio is of at least 1.25, preferably of at least 1.30, more preferably of at least 1.40, even more preferably of at least 1.45, and most preferably of at least 1.50.

Advantageously, the RHO-type zeolite has an average crystal size comprised between 20 nm and 300 nm as determined by the Scherrer equation, preferably between 30 nm and 250 nm, more preferably between 40 nm and 200 nm, even more preferably between 50 nm and 150 nm, most preferably between 60 nm and 100 nm. The small size of the crystal allows for providing high accessibility of the zeolite when used as a catalyst. This provides a fast diffusion of the interacting components.

The RHO-type zeolite has advantageously an M¹/Al molar ratio ranging from 0.60 and 0.90 as determined by Inductively Coupled Plasma Optical Emission Spectrometry wherein M¹ is selected from Na and/or Li; preferably from 0.65 to 0.80; preferably between 0.67 and 0.78, more preferably between 0.70 and 0.75. For example, the RHO-type zeolite has a Na/Al molar ratio determined by inductively coupled plasma optical emission spectrometry comprised between 0.65 and 0.80, preferably between 0.67 and 0.78, more preferably between 0.70 and 0.75.

The RHO-type zeolite has advantageously an M¹/Cs molar ratio comprised ranging from 1.5 to 5.0 as determined by Inductively Coupled Plasma Optical Emission Spectrometry wherein

M¹ is selected from Na and/or Li; preferably from 2.0 to 5.0, more preferably from 2.5 to 4.5, and even more preferably from 3 to 4. For example, the RHO-type zeolite has a Na/Cs molar ratio determined by inductively coupled plasma optical emission spectrometry comprised between 2 and 5, preferably between 2.5 and 4.5, more preferably between 3 and 4. This high level of cation reduces the accessibility of pores and favours the sorption of carbon dioxide selectively over methane or nitrogen.

The RHO-type zeolite has advantageously a Cs/Al molar ratio ranging from 0.10 to 0.50 as determined by Inductively Coupled Plasma Optical Emission Spectrometry; preferably from 0.14 to 0.45, more preferably from 0.18 to 0.40, even more preferably from 0.19 to 0.38, most preferably from 0.20 to 0.35.

The RHO-type zeolite preferably comprises a combination of at least two lta cages linked by one 8-membered double ring.

In a first embodiment, the RHO-type zeolite forms nanoparticles which are nanocrystals with a hexagonal shape, as determined by transmission electron microscopy. The nanoparticles have preferably an average crystal size of at least 20 nm as determined by Scherrer equation, more preferably at least 30 nm; even more preferably at least 40 nm and most preferably at least 50 nm and even most preferably at least 60 nm. For example, the nanoparticles have an average crystal size of at most 350 nm as determined by the Scherrer equation, preferably at most 300 nm and more preferably at most 250 nm.

In a second embodiment, the RHO-type zeolite forms aggregate, preferably aggregate of nanocrystals. The aggregates have preferably a size ranging between 150 nm and 450 nm as determined by scanning electron microscopy, more preferably comprised between 200 nm and 400 nm, even more preferably comprised between 250 nm and 350 nm, most preferably between 275 nm and 300 nm. For example, the aggregates have an average size of at least 120 nm as determined scanning electron microscopy; preferably at least 150 nm, more preferably at least 200 nm; even more preferably at least 250 nm and most preferably at least 275 nm. For example, the aggregates have an average size of at most 480 nm as determined by scanning electron microscopy; preferably at most 450 nm, more preferably at most 400 nm, even more preferably of at most 350 nm, most preferably of at most 320 nm and even most preferably of at most 300 nm.

The use of the RHO-Type Zeolite

The disclosure provides for the use of the RHO-type zeolite as described above as a sorbent of carbon dioxide. The disclosure further provides for a use of the RHO-type zeolite as described above as adsorbent for carbon dioxide, preferably as selective adsorbent towards carbon dioxide over methane and nitrogen. With preference, the use is made in a process for separation of carbon dioxide from methane or in a process for separation of carbon dioxide from an inert gas, such as N2, He and/or Ar. The low Si/Al molar ratio, which allows for high content of cation, reduces the accessibility of nitrogen (having a diameter of 3.6 Å) and of methane (having a diameter of 3.8 Å) while the carbon dioxide (being smaller, with a diameter of 3.3 Å) can be adsorbed and desorbed with the RHO-type zeolite of the present disclosure In addition to the size of the molecules, the electronic interactions and/or the electronic repulsion play an essential role in the possibility of the molecule to displace the cations to enter the zeolite.

The disclosure also provides for a use of the RHO-type zeolite as described above in a method of preparing clathrate hydrate substance, wherein said clathrate hydrate substance entraps preferably methane. The RHO-type zeolite is contacted with a gaseous water feed and a gaseous material, for instance methane, under determined conditions of temperature and pressure. this instance, methane, can thus be entrapped into a lattice of water and forming thus a clathrate hydrate entrapping methane.

Further use of the RHO-type zeolite as described above is its use as a catalyst in a chemical process. For instance, said chemical process can be the conversion of methyl halides to olefins, the conversion of sulfurized hydrocarbons to olefins, the partial oxidation of methane, the oligomerizing of alkenes, the carbonylation of dimethyl ether with carbon monoxide, the methylation of amines, a cracking process, a dehydrogenating process, the isomerization of olefins, or a reforming process.

Test and Determination Methods

The various RHO-type zeolites obtained in the examples were characterized over the following methods and, except the mention of the contrary, after a step of drying which is preferably performed by lyophilization (i.e. freeze-drying), said lyophilization being more preferably carried out at a temperature ranging between −92° C. and −76° C.

Powder X-ray diffraction (XRD) analysis, carried out on powder samples of the synthetic RHO-type zeolite, was performed using a PANalytical X'Pert Pro diffractometer with CuKα monochromatized radiation (γ=1.5418 Å, 45 kV, 40 mA). The samples were scanned in the range 3-70° 2θ with a step size of 0.016°.

The Scherrer equation links the broadening of the XRD peaks to the size of the crystallites. It has been used to quantify the size of crystals in powder form using powder XRD pattern and X-Pert software. The first Bragg peak of the XRD pattern is usually taken into consideration.

Scanning electron microscopy (SEM) analysis was used to determine the surface features, morphology, homogeneity and size of RHO zeolite nanocrystals obtained after the step (f), when said step is carried out, of recovering said one or more crystals of RHO-type zeolites. SEM analysis can also be carried out after the drying step. SEM was carried out by using a field-emission scanning electron microscope using a MIRA-LMH (TESCAN) fitted with a field emission gun using an accelerating voltage of 30.0 kV. All samples before the SEM characterization were covered with a conductive layer (Pt or Au).

Transmission electron microscopy (TEM) was carried out determine the crystal size, morphology and crystallinity of solids using a JEOL 2010 FEG or TECHNAI operating at 200 kV. TEM is used to reveal the shape of the nanocrystals.

Inductively coupled plasma (ICP) optical emission spectrometry was used to determine the chemical compositions using a Varian ICP-OES 720-ES. The Na/Al molar ratio and the Na/Cs molar ratio of the RHO-type zeolite has thus been determined using this technical method.

Energy-dispersive X-ray Transmission Electron Microscopy (EDX-TEM) was used to determine the chemical compositions using a JEOL Model 2010 FEG system fitted with an EDX analyzer operating at 200 kV on diluted colloidal suspensions of zeolite materials obtained either after step (f) or after the drying step, that was sonicated for 15 min. Then 2-3 drops of fine particle suspensions were dried on carbon-film-covered 300-mesh copper electron microscope grids. EDX-TEM is an alternative method to determine the composition of the zeolite such as the Cs content or the molar ratios. In such a case, at least ten analysis of the same zeolite material at different TEM spots are averaged to obtain the chemical composition of the zeolite materials. The Si/Al molar ratio, the Cs/Al molar ratio, the M1/Cs molar ratio, the Na/Al molar ratio and the Na/Cs molar ratio of the zeolite can be determined using this technical method.

High-Resolution transmission electron microscopy (HR-TEM) has been used to determine the crystal size, morphology, crystallinity and chemical composition of the crystalline solid of RHO-type zeolite. It was operated by HR-TEM using a JEOL Model 2010 FEG system fitted with an EDX analyzer operating at 200 kV on diluted colloidal suspensions of zeolite materials obtained either after step (f) or after the drying step, that was sonicated for 15 min. Then 2-3 drops of fine particle suspensions were dried on carbon-film-covered 300-mesh copper electron microscope grids.

Nuclear Magnetic Resonance (NMR) analysis was performed to determine the crystallinity and the Si/Al molar ratio of the zeolite materials obtained after the drying step. The NMR spectrum was determined by ²⁹Si and solid-state magic angle spinning (MAS) NMR on a Bruker Avance III-HD 500 (11.7 T) spectrometer operating at 99.3 MHz, using 4-mm outer diameter zirconia rotors spun at 12 kHz. ²⁹Si chemical shift was referenced to tetramethylsilane (TMS). The molecular geometry of aluminium was determined using ²⁷A1 MAS NMR on a Bruker Avance III-HD 500 (11.7 T) spectrometer using 4-mm outer diameter zirconia rotors spun at 14 kHz. ²⁷AI chemical shift was referenced to aluminium ammonium sulphate.

The ²⁹Si chemical shift sensitivity is an indication of the degree of condensation of the Si-O tetrahedra, that is, the number and type of tetrahedrally coordinated atoms connected to a given SiO₄ unit. Furthermore, ²⁹Si MAS NMR spectra can be used to calculate the Si/Al molar ratio from the NMR signal intensities (I) according to eq. (1):

$$\frac{Si}{Al} = \frac{{\sum }_{n = 0}^{4} {I}_{S i ( n A l )}}{{\sum }_{n = 0}^{4} 0.25 {nI}_{Si ( n A l )}} \qquad ( 1 )$$

wherein n indicates the number of Al atoms sharing the oxygen atom of the SiO₄ tetrahedron under consideration and wherein n=0, 1, 2, 3 or 4.

The chemical shift range of the silicon atom is comprised between −80 ppm to −115 ppm, with the high-field signal for the silicon atom directly linked to the oxygen atom of the -0-Al moiety. The differences in chemical shifts between Si (n Al) and Si (n+1 Al) are about 5-6 ppm in the low-field signal.

N₂ sorption analysis was used to determine the nitrogen adsorption/desorption isotherms using Micrometrics ASAP 2020 volumetric adsorption analyzer. The dried samples were degassed at 523 K (249.85° C.) under vacuum overnight before the measurement. From these measurements, the pore volume accessible to N₂ of the RHO-type zeolite has been determined.

Thermogravimetry analyses (TGA) and Differential Thermal analysis (DTA) were performed on zeolite nanocrystals obtained when the step (f) of recovering said one or more crystals of RHO-type zeolite is performed (before drying). TGA and DTA were carried out on a SETSYS 1750 CS evolution instrument (SETARAM). The sample was heated from 25° C. to 800° C. with a heating ramp of 5° C./min under carbon dioxide or nitrogen (flow rate: 40 mL/min).

After activation (water and CO₂ desorption) at 350° C. for 2 hours, the zeolitic material was allowed to return and stay at room temperature under a continuous flow of CO₂ (flow rate: 40 mL/min, 1 bar) in 9 hours. The quantity of CO₂ absorbed was determined using the mass increase compared to the total mass of the sample.

Cycles of CO₂ adsorption/desorption were conducted and monitored by TGA. An alternance between activation at 350° C. for 2 hours under N₂ flow (flow rate: 40 mL/min) and CO₂ adsorption at room temperature (flow rate: 40 mL/min, 1 barg) for 2 hours has been performed 10 consecutive times.

Carbon dioxide adsorption/desorption isotherms were measured using Micrometrics ASAP 2020 volumetric adsorption analyzer. Samples of the RHO-type zeolite materials obtained after drying were degassed at 523 K (249.85° C.) under vacuum overnight before the measurement.

Fourier Transformation Infra-Red (FTI R) spectroscopic analysis was conducted to characterize the selective adsorption of CO₂ and CH₄ with nanosized RHO-type zeolite. The transmission IR spectra were recorded with a Nicolet Avatar spectrometer. A room temperature IR-cell equipped with a heating device offered the possibility to activate the samples at 350° C. before the measurements. The cell was connected to a high vacuum line with a reachable pressure of 10⁻⁵ Pa. Three-step activation was applied to the samples: a first step at 100° C. for 0.5 h to desorb most the adsorbed water, second and third steps at 350° C. for 3.0 hours. All the above steps were performed under secondary vacuum. Little doses of gas have been incrementally introduced onto the RHO pellet (10 mg cm⁻²) present in FTIR cell at room temperature. All IR spectra were recorded at room temperature, and as a background, the IR spectrum recorded in empty transmission cell under secondary vacuum at room temperature was used.

### EXAMPLES

The embodiments of the present disclosure will be better understood by looking at the different examples below.

The starting materials used in the examples presented below are listed as follow:

sodium hydroxide: (pellets, purity >99%): Sigma Aldrich;

caesium hydroxide (purity >98%, aqueous 50%): Alfa Aesar;

colloidal silica (Ludox-HS 30, 30 wt. % SiO₂, pH =9.8): Sigma Aldrich;

colloidal silica (Ludox-AS 40, 40 wt. % SiO₂): Sigma Aldrich;

sodium aluminate (Al₂O₃ 53%, Na₂O 47% by mass): Sigma Aldrich

These starting materials were used as received from the manufacturers, without additional purification.

### Example 1

### Preparation of Aggregated RHO-Type Zeolite (RHO-1)

A first aqueous suspension comprising aluminate was prepared by mixing 516 mg of sodium aluminate in 3 g of double-distilled H₂O. This suspension is clear.

A second aqueous suspension comprising silicate was prepared by mixing 5.0 g of LUDOX AS40 with 1.82 g of sodium hydroxide and 0.588 g of caesium hydroxide. The reaction is a gel. After vigorous shaking by hand, the reaction turns into a clear suspension thanks to its exothermic character. The second aqueous suspension was stirred at room temperature (i.e., 25° C.).

The first aqueous suspension was added dropwise to the second aqueous suspension. During the addition, the second aqueous suspension was maintained at room temperature while being vigorously stirred. A clear aqueous suspension was obtained.

The resulting amorphous precursor in the clear aqueous suspension has the following molar composition:

10 SiO₂: 0.8 Al₂O₃: 8 Na₂O: 0.58 Cs₂O: 100 H₂O

The pH of said clear aqueous suspension is 12, and water clear suspension is obtained.

The resulting clear aqueous suspension was then aged by magnetic stirring for 14h at room temperature.

Then, the hydrothermal crystallization was conducted during 1 hour at 100° C. to obtain a solid comprising nanocrystals of synthetic zeolite material RHO-1, said solid being dispersed in the mother liquor.

The solid was then separated and recovered by high-speed centrifugation (20000 rpm, 10 min) and several washes with hot double distilled water (heated at 100° C. for 30 min) were performed until the pH of the remaining water was 7.5.

Nanocrystals of zeolite material RHO-1 were thus obtained. The Si/Al molar ratio has been determined to be 1.46. Also, the Na/Al molar ratio has been determined to be 0.80 and the Na/Cs molar ratio has been determined to be 4. The above ratios were determined by Inductively Coupled Plasma Optical Emission Spectrometry.

The nanocrystals have a size of 30 nm and form aggregates with a size ranging between 300 nm and 400 nm as determined by SEM.

The yield in nanocrystal of RHO-1 was measured to be of 65% by mass.

The chemical composition of RHO-1 has been determined by ICP analysis and is as follows:

Na_{15.6}Cs_{3.9}Si_{28.5}Al_{19.5}O₉₆

This example provides aggregate of RHO-type nanosized zeolites having a low Si/Al molar ratio and high content of Na and Cs cations.

### Example 2

### Preparation of Monodispersed RHO-Type Zeolite (RHO-2)

A first aqueous suspension was prepared by mixing 516 mg of sodium aluminate in 3 g of double-distilled H₂O. This suspension is clear.

1.82 g of sodium hydroxide and 588 mg of caesium hydroxide were added to the first aqueous suspension. During the addition, the first aqueous suspension was maintained at room temperature (i.e. 25 ° C.) while being vigorously stirred. The stirring at room temperature was continued for at least 2 hours and afforded a clear aqueous suspension.

A second aqueous suspension comprising a silicate, namely 5 g of LUDOX AS40, was added dropwise. During the addition, it was maintained at room temperature while being vigorously stirred.

The resulting amorphous precursor in the clear aqueous suspension has the following molar composition:

10 SiO₂: 0.8 Al₂O₃: 8 Na₂O: 0.58Cs₂O: 100 H₂O

The pH of said clear aqueous suspension is 12.

The clear aqueous suspension was then aged by magnetic stirring for 14 hours at room temperature.

Then, the hydrothermal crystallization was conducted at 90° C. for 1 hour to obtain a solid comprising nanocrystals of synthetic zeolite material RHO-2, said solid being dispersed in the mother liquor.

The solid was separated and recovered by high-speed centrifugation (20000 rpm, 10 min) and several washes with hot double distilled water (heated at 100° C. for 30 min) until the pH of the remaining water was about 7.5.

Nanocrystals of synthetic zeolite material RHO-2 with a Si/Al molar ratio of 1.5, a Na/Al molar ratio of 0.71 and a Na/Cs molar ratio of 2.49 were obtained. The above ratios were determined by Inductively Coupled Plasma Optical Emission Spectrometry.

The nanocrystals had a size of 80 nm with a hexagonal shape as determined by SEM.

The yield in nanocrystal of RHO-2 was 65% by mass.

The chemical composition of RHO-2 has been determined by ICP analysis and is as follows:

Na_{13.7}Cs_{5.2}Si_{29.3}Al18.8O₉₆

This example provides monodispersed RHO-type nanosized zeolites having a low Si/Al molar ratio and high content of Na and Cs cations.

### Example 3

### Preparation of Higher Silica Containing-RHO-Type Zeolite (RHO-3) in Monodispersed Form

A first aqueous suspension was prepared by mixing 516 mg of sodium aluminate in 3 g of dd H₂O. This suspension is clear.

1.55 g of sodium hydroxide and 336 mg of caesium hydroxide were added to the clear suspension. During the addition, the first aqueous suspension was maintained at room temperature (i.e. 25 ° C.) while being vigorously stirred. The stirring at room temperature was continued for at least 2 hours and afforded a clear aqueous suspension.

A second aqueous suspension comprising a silicate, namely 5 g of LUDOX AS40, was added dropwise. During the addition, it was maintained at room temperature while being vigorously stirred.

The resulting amorphous precursor in the clear aqueous suspension has the following molar composition:

10 SiO₂: 0.8 Al₂O₃: 6.6 Na₂O: 0.33 Cs₂O: 100 H₂O (III)

The pH of said clear aqueous suspension is 12.

The resulting clear aqueous suspension was then aged by magnetic stirring for 14 hours at room temperature.

Then, the hydrothermal crystallization was conducted at 90° C. for 5 hours to obtain a solid comprising nanocrystals of synthetic zeolite material RHO-3, said solid being dispersed in the mother liquor.

The solid was separated and recovered by high-speed centrifugation (20000 rpm, 10 min) and several washes with hot double distilled water (heated at 100° C. for 30 min) until the pH of the remaining water was about 7.5.

Nanocrystals of synthetic zeolite material RHO-3 with a Si/Al molar ratio of 1.83, a Na/Al molar ratio of 0.69 and a Na/Cs molar ratio of 2.31 were obtained. The above ratios were determined by Inductively Coupled Plasma Optical Emission Spectrometry.

The nanocrystals had a size of 150 nm as determined by SEM.

The yield in nanocrystaf RHO-3 was 65% by mass.

The chemical composition of RHO-3 has been determined by ICP analysis and is as follows:

Na_{11.5}Cs_{5.8}Si_{30.6}Al17.4O₉₆

This example provides monodispersed RHO-type nanosized zeolites having a higher Si/AI molar ratio and lower content of Na and Cs cations.

The samples RHO-1, RHO-2 and RHO-3 were characterized by using XRD, NMR, SEM, HR-TEM, TGA and N₂ sorption methods.

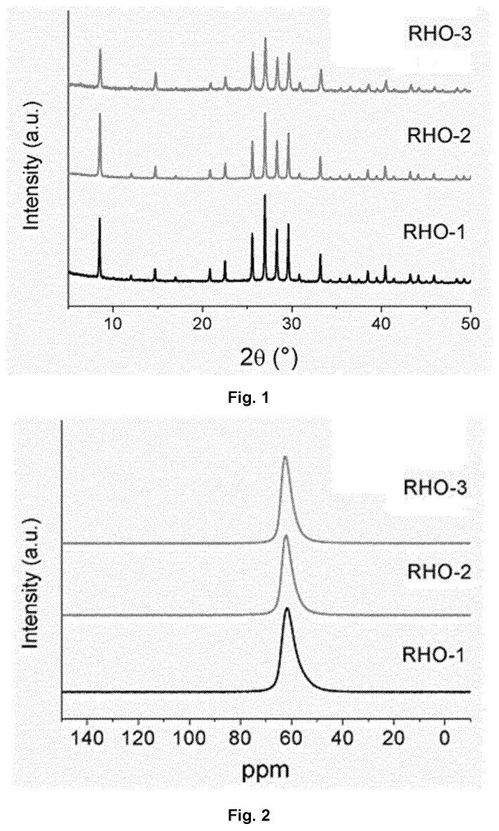

The XRD analysis, displayed in FIG. 1, shows only Bragg peaks corresponding to RHO-type zeolite. Also, the XRD patterns display distinct broad diffraction peaks, typical for nanosized RHO-type zeolite nanocrystals.

FIG. 2 displays the ²⁷Al MAS NMR spectrum of the RHO-type zeolites of the examples. A single peak can be observed at around 60 ppm. This corresponds to aluminium in a tetrahedral position. No peaks at 0 ppm are observed, which means that aluminium is not octahedral aluminium.

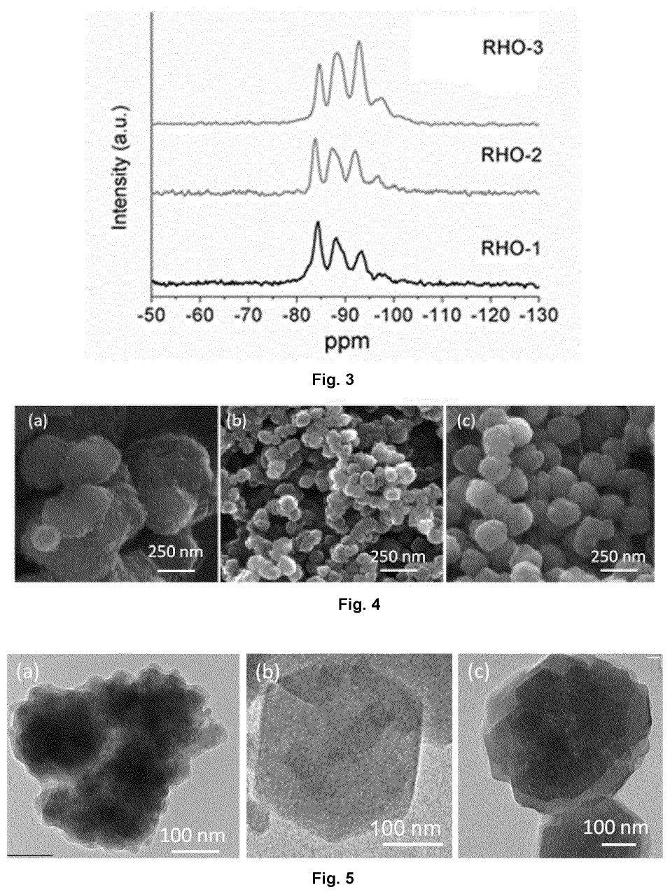

FIG. 3 displays the ²⁹Si MAS NMR spectrum of the RHO-type zeolites of the examples. Peaks corresponding to Q⁰ (4Al), Q¹(3Al), Q²(2Al), Q³ (1Al) and Q⁴ (0Al) types of silicon tetrahedrons can be observed at around −84 ppm, −88 ppm, −92 ppm, −98 ppm and −102 ppm respectively. After being normalized with the mass of material samples, those peaks have been deconvoluted and their respective areas allowed the calculation of following Si/Al molar ratio of RHO-1, RHO-2 and RHO-3 zeolite materials: 1.35; 1.55 and 1.77, respectively.

The ICP analyses confirmed the range of those Si/Al molar ratios: 1.46, 1.50 and 1.83 obtained for RHO-1, RHO-2 and RHO-3 zeolite materials, respectively.

FIG. 4 shows the SEM images which reveal the presence of aggregates of nanocrystals with a size between 300 to 500 nm (FIG. 4a), nanocrystals having a size below 100 nm (FIG. 4b) and aggregates of nanocrystals with a size of 150 nm (FIG. 4c) corresponding to RHO-1, RHO-2 and RHO-3 respectively.

FIG. 5 shows the TEM images which reveal the shape of the nanocrystal of the RHO-type zeolite. TEM images confirmed the size and degree of aggregation of zeolite crystals observed in SEM images. Also, it reveals that nanocrystals of RHO-1, obtained when the addition of the one or more sodium precursors and the one or more caesium precursor is carried out in the second aqueous suspension comprising the one or more silicate precursors, are poorly defined (FIG. 5a), while the nanocrystals of RHO-2 and RHO-3, obtained when the addition of the one or more sodium precursors and the one or more caesium precursor is carried out in the first aqueous suspension comprising the one or more aluminate precursors, have a clear hexagonal shape (FIG. 5b), even aggregated (FIG. 5c).

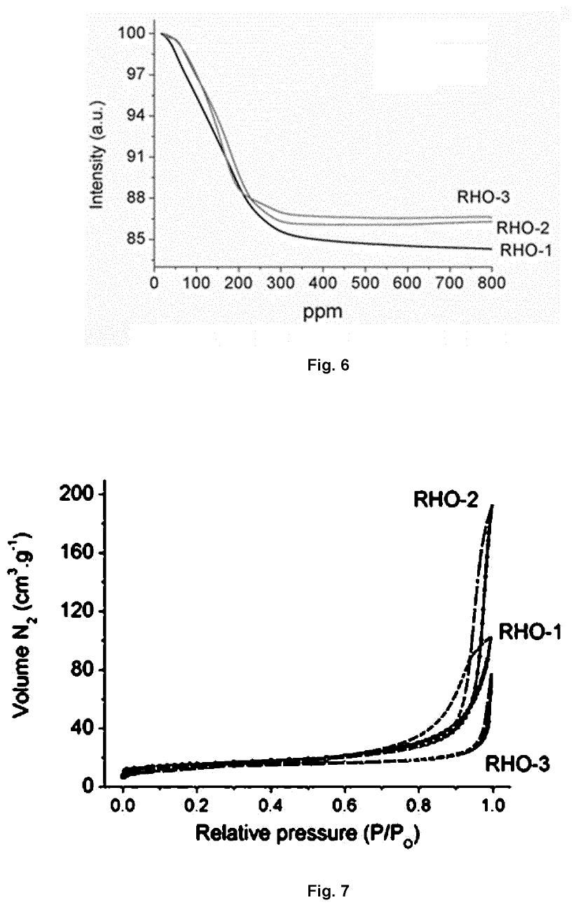

FIG. 6 displays the thermogravimetric analysis (TGA) to reveal the quantity of water absorbed by the RHO-type zeolite. It is visible that a similar amount of water has been absorbed by the three zeolitic materials with a slight, but expected, increase for the RHO-1 having a lower Si/Al molar ratio. The mass of water reported to the total mass of the zeolite materials is 15.7%, 13.9% and 13.3% for RHO-1, RHO-2 and RHO-3 zeolite materials, respectively.

FIG. 7 displays the N₂ sorption isotherms of the RHO-type zeolite of the present disclosure. Very low microporosity is observed as a polar molecule such as N₂ is not able to enter the micropores being blocked by cations (Na⁺, Cs⁺) contained in the zeolite structures. Nevertheless, the substantially high total pore volume is explained by the high external surface area due to the nanometer size of the crystals.

### Example 4

### Use of the RHO-Type Zeolite of the Present Disclosure as Adsorbents for CO₂.

The detection of CO₂ gases with RHO-1, RHO-2 and RHO-3 zeolite materials prepared in examples 1, 2 and 3 respectively were studied using CO₂ sorption isotherms, FTIR and TGA.

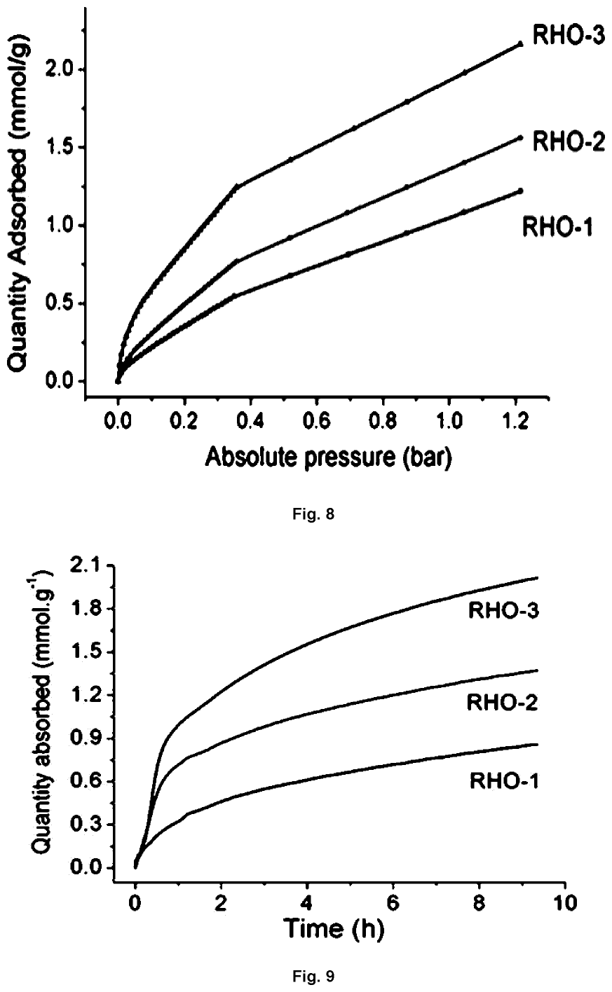

FIG. 8 represents the CO₂ sorption isotherms. The CO₂ isotherms have been recorded up to 900 mmHg which corresponds to a relative pressure of 0.35 due to instrument limitations. All isotherms described a similar trend of adsorption of CO₂, specifically a Langmuir shape until P/P°=0.01 followed by a nearly linear trend up to P/P°=0.03. It has been calculated that at the highest pressure reached (P=1.2 bar) and at room temperature, the RHO-1, RHO-2 and RHO-3 zeolite materials absorbed 1.22, 1.56 and 2.16 mmol of CO₂ per gram of zeolite material, respectively.

FIG. 9 represents the sorption capacity towards CO₂. The analysis of the thermogravimetry showed that 8.70% of CO₂ has been absorbed by the RHO-3 zeolite material under 1 bar of CO₂ at room temperature, which corresponds to 2.01 mmol of CO₂ per gram of zeolite material. Similarly, RHO-1 and RHO-2 were found to absorb 0.87 and 1.37 mmol.g⁻¹, respectively.

Moreover, under 1 bar, the very similar values were obtained using BET (see table 1)

TABLE 1
Sorption capacity of the RHO-type zeolite
determined either by BET or TGA.

| | BET (mmol · g⁻¹) | TGA (mmol · g⁻¹) |
|---|---|---|
| RHO-1 | 1.08 | 0.87 |
| RHO-2 | 1.40 | 1.37 |
| RHO-3 | 1.98 | 2.01 |

### Example 5

### Use of the RHO-Type Zeolite of the Present Disclosure as Sorbents for CO₂ During Several Cycles of Adsorption and Desorption.

The detection of carbon dioxide gas with RHO-3 zeolite was studied using FTIR and TG.

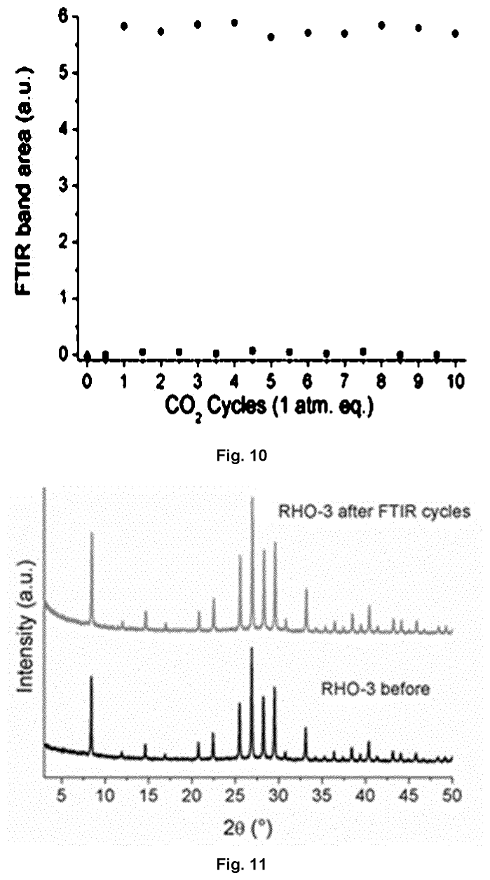

In FIG. 10, ten consecutive cycles of CO₂ adsorption at 1 atm, followed by desorption at 350° C., have been performed and monitored by the integration of the FTIR bands attributed to physisorbed and chemisorbed CO₂ within RHO-3 zeolite material. The adsorption capacity is not perturbed even after 10 cycles as the band areas (materialized by the rounds on FIG. 10) reached the same level (around 6) in all cycles. Also, this adsorption appeared fully reversible as the band area after 350° C. desorption (materialized by the square on FIG. 10) always reached back the initial reference point (triangle mark). Moreover, no crystalline loss could be observed by XRD after the consecutive cycles monitored by FTIR (FIG. 11).

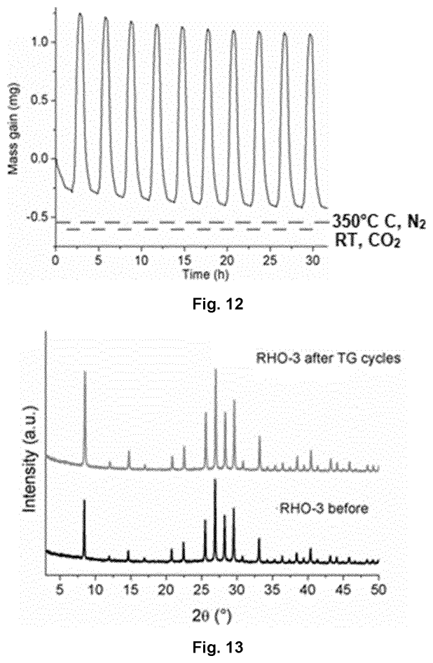

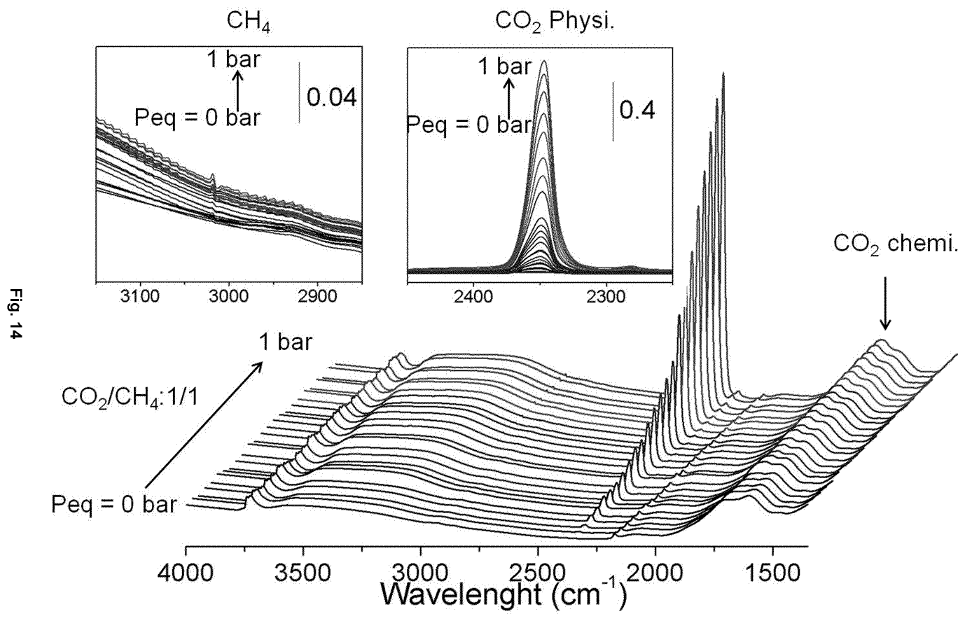

FIG. 12 confirms by TGA that the adsorption capacity of RHO-3 zeolite material is preserved during the ten cycles at 1 bar followed by desorption at 35° C. FIG. 13 also demonstrates that no crystalline loss is observed with XRD after ten consecutive cycles.

These experiments show that the RHO-3 zeolite material is stable under CO₂ sorption cycles.

### Example 6

### Use of the RHO-Type Zeolite of the Present Disclosure as Selective Adsorbents Towards Carbon Dioxide Over Methane

The detection of a mixture of CO₂ and CH₄ (1/1 in volume) gases up to 1 bar with RHO-3 zeolite material prepared in Example 3 was studied. The zeolite materials were used as self- supported pellets and the detection was followed using in situ FTIR spectroscopy.

The CO₂ absorption phenomenon is due to physisorption (band at around 2650 cm⁻¹) as well as chemisorption by the formation of carbonates (bands at around 1650 cm^{-l}and below), as shown by FIG. 14. This phenomenon is fully reversible desorbed at 150° C. under vacuum. At the same time, no CH₄ adsorption could be observed. Indeed, only free CH₄ molecules afford the very small rotational bands observed at 3050 cm⁻¹ on FIG. 14.

1.-28 (canceled)

29. An RHO-type zeolite comprising caesium and M¹ wherein M¹ is Na, characterized in that the RHO-type zeolite has a Si/Al molar ratio comprised between 1.2 and 2.40 as determined by ²⁹Si magic angle spinning nuclear magnetic resonance, in that the RHO-type zeolite has a specific surface area comprised between 40 m²g⁻¹ and 250 M²g⁻¹ as determined by N₂ adsorption measurements, in that the RHO-type zeolite is in the form of one or more nanoparticles, and in that the nanoparticles have an average crystal size ranging from 40 nm to 400 nm as determined by Scherrer equation; wherein said nanoparticles form monodispersed nanocrystals or form aggregates of nanocrystals having an average size ranging from 100 nm to 500 nm, as determined by scanning electron microscopy.

30. The RHO-type zeolite according to claim 29, characterized by a Si/Al molar ratio of at most 2.00 as determined by ²⁹Si magic angle spinning nuclear magnetic resonance.

31. The RHO-type zeolite according to claim 29, characterized by a Cs/Al molar ratio ranging from 0.10 to 0.50 as determined by Inductively Coupled Plasma Optical Emission Spectrometry.

32. The RHO-type zeolite according to claim 29, characterized by having a pore volume comprised between 0.06 cm³g⁻¹ and 0.40 cm³g⁻¹, as determined by analysis of N₂ sorption isotherms.

33. The RHO-type zeolite according to claim 29, characterized by having an M¹/Al molar ratio ranging from 0.60 and 0.90 as determined by Inductively Coupled Plasma Optical Emission Spectrometry wherein M¹ is Na.

34. The RHO-type zeolite according to claim 29, characterized by having an M¹/Cs molar ratio comprised ranging from 1.5 to 5.0 as determined by Inductively Coupled Plasma Optical Emission Spectrometry wherein M¹ is Na.

35. The RHO-type zeolite according to claim 29, characterized in that the aggregates have an average size ranging from 150 nm to 450 nm, as determined by scanning electron microscopy.

36. The RHO-type zeolite according to claim 29, characterized in that the nanoparticles have an average crystal size of at least 50 nm to at most 350 nm as determined by Scherrer equation.

37. An amorphous precursor for the preparation of an RHO-type zeolite according to claim 29, characterized in that said amorphous precursor of RHO-type zeolite has a molar composition comprising
10 SiO₂: a Al₂O₃: b M¹₂O: c Cs₂O: d H₂O,
wherein a, b, c, and d are coefficients; wherein
the coefficient a is ranging from at least 0.6 to at most 1.2;
the coefficient b is ranging from at least 6.5 to at most 9.0;
the coefficient c is ranging from at least 0.25 to at most 0.70; and
the coefficient d is ranging from at least 70 to at most 300;
wherein M¹ is Na;
wherein the (M¹₂O+Cs₂O)/SiO₂ ratio is at least 0.60; and
wherein the ratio M¹₂O/H₂O is superior or equal to 0.03.

38. The amorphous precursor of RHO-type zeolite according to claim 37, characterized in that said amorphous precursor of RHO-type zeolite has a pH ranging between 12 and 14.

39. The amorphous precursor of RHO-type zeolite according to claim 37, characterized in that the coefficient a is ranging from at least 0.8 to at most 1; and/or the coefficient b is ranging from at least 6.5 to at most 8.5.

40. The amorphous precursor of RHO-type zeolite according to claim 37, characterized in that the coefficient c is ranging from at least 0.29 to at most 0.60; and/or the coefficient d is ranging from at least 80 to at most 250.

41. The amorphous precursor of RHO-type zeolite according to claim 37, characterized in that the (M¹₂O+Cs₂O)/SiO₂ ratio is ranging from 0.60 to 1.00, wherein M¹ is Na.

42. The amorphous precursor of RHO-type zeolite according to claim 37, characterized in that the ratio M¹₂O/H₂O is greater than or equal to 0.07.

43. The amorphous precursor of RHO-type zeolite according to claim 37, wherein the ratio M¹₂O/Al₂O₃ is greater than or equal to 7.0.

44. The amorphous precursor of RHO-type zeolite according to claim 37, characterized in that the ratio Cs₂O/Al₂O₃ is less than or equal to 0.80.

45. A method for the preparation of an amorphous precursor of an RHO-type zeolite, comprising the following steps,
a) providing an aluminate precursors aqueous suspension;
b) providing a silicate precursors aqueous suspension;
c) adding one or more caesium precursors and one or more additional precursors selected from one or more sodium precursors; in the said aluminate precursors aqueous suspension to form a first aqueous suspension and/or in the said silicate precursors aqueous suspension to form a second aqueous suspension;
d) forming an amorphous precursor of RHO-type zeolite by adding dropwise said aluminate precursors aqueous suspension into said second aqueous suspension or by adding dropwise said silicate precursors aqueous suspension into said first aqueous suspension, or by adding dropwise the said first or the said second aqueous suspension into said second or said first aqueous suspension;
wherein said first aqueous suspension and said second suspension are organic structure-directing agent-free.

46. The method according to claim 45, characterized in that said step (c) is the step of adding one or more caesium precursors and one or more additional precursors selected from one or more sodium precursors in the aluminate precursors aqueous suspension to form a first aqueous suspension and said step (d) is the step of adding dropwise the silicate precursors aqueous suspension on the first aqueous suspension.

47. A method for the preparation of an RHO-type zeolite comprising the method for the preparation of an amorphous precursor of an RHO-type zeolite according to claim 45 wherein step comprises c) of adding in the aluminate precursors aqueous suspension one or more caesium precursors and one or more additional precursors selected from one or more sodium precursors to form a first aqueous suspension and wherein step (d) comprises the step of adding dropwise the silicate precursors aqueous suspension on the first aqueous suspension; wherein upon crystallization, the amorphous precursors will form discrete RHO-type nanosized zeolites being monodispersed nanocrystals.

48. A method for the preparation of an RHO-type zeolite comprising the method for the preparation of an amorphous precursor of an RHO-type zeolite according to any one of claim 45, wherein step c) comprises adding one or more caesium precursors and one or more additional precursors selected from one or more sodium precursors in the silicate precursors aqueous suspension to form a second aqueous suspension and step (d) comprises the step of adding dropwise the aluminate precursors aqueous suspension on the second aqueous suspension; wherein upon crystallization, the amorphous precursors will form aggregates of RHO-type nanosized zeolite.
